(19) United States
(12) Patent Application Publication
(10) Pub. No.: US 2008/0122364 A1
(43) Pub. Date: May 29, 2008

(54) Light device having LED illumination and an electronic circuit board

(76) Inventor: Thomas McClellan, Santa Cruz, CA (US)

Correspondence Address: WAGNER, MURABITO & HAO LLP, Third Floor, Two North Market Street, San Jose, CA, 95113, US

(21) Appl. No.: 11/605,794

(22) Filed: Nov. 27, 2006

(51) Int. Cl. H01J 7/24; H02H 9/04; H05B 41/36

(52) U.S. Cl. 315/51; 361/91.1; 315/291; 315/294

(57) ABSTRACT

A light device having an electronic circuit board light emitting diode (LED) illumination. In one embodiment an LED is disposed on a single board which is operable with a power supply and equipped with a heat sink for dissipating heat. In one embodiment, the heat sink is formed by at least one layer of nickel and silver plate distributed over the single board. The heat sink may also be formed by a plurality of vias for allowing air flow to dissipate heat. The single board further contains a converter for accepting multiple input voltages and providing conversion to a voltage operable for the LED. The device further includes an over voltage protection component for preventing damage to the electronic components if an input voltage outside of their operating range is applied. A dimming component is used and is operable with an external dimming component belonging to other electronic devices.

### TECHNICAL FIELD

Embodiments of the present invention relate to the field of electronics and lighting. More particularly, embodiments of the present invention relate to electronics and lighting devices that provide illumination using light emitting diode (LED).

### BACKGROUND ART

Typically, a light emitting diode (LED) is designed to operate with no more than 30-60 milliwatts of electrical power because higher power reduces its lifespan and heat generated by the LED may damage its operation or render it inoperable. However, in recent years, LED components with much larger semiconductor die sizes have been developed to allow operation with higher power inputs.

High power LED components are desirable because they produce more light and use less power over conventional light sources. For example, LED components use 5-10 times less energy than a florescent light and produce significantly more lumens. For instance, Lumileds has developed a 5-watt LED available with efficiencies of 18-22 lumens per watt, and a 1-watt LED with efficiency of 65 lumens. Other manufacturers have followed by developing higher power LED components (e.g., Cree Inc. developed an LED having 65 lumens per watt at 20 mA). As the need for conserving energy increases, a need for a more efficient method of producing more lumens per unit of energy increases as well. High power LED components do not only help to conserve energy by virtue of their high efficiency but they produce more lumens per unit of energy as well.

Unfortunately, the higher the power the more heat is generated by the LED. As a result, the lifespan of the LED may be reduced and if the generated heat is not addressed, the LED component may be damaged. Conventional LED light devices use large heat sink components such as a metal slug. In general, the LED is mounted on a printed circuit board (PCB) which is separate from the metal slug that allows the heat to be removed from the LED die. For example, a PCB is usually used to house the LED and another PCB with metal slug is used that acts as a heat sink such that the heat is transferred from the front of the PCB housing the LED to the back of the heat sink PCB. Additionally, PCBs may also be needed for driver circuitry.

Unfortunately the higher the power used for an LED, the larger the semiconductor die size is needed along with a larger heat sink. Moreover, in order to efficiently dissipate the heat, a separate PCB is used. Using additional space for dissipating the heat renders the conventional LED lighting device bulky and not readily usable in small fixtures (e.g., a light fixture).

Moreover, conventional LED driver components are not equipped with a component stepping up or down the input voltage (e.g., converter) such that the LED can be used universally and without the need for an external transformer. For example, there are currently no LED driver component to take a wide voltage input and produce the voltage and current required to operate the LED component (e.g., 350 mA-1000 mA and 3.2v).

Moreover, LED driver components are in general not equipped with over voltage protection to protect the LED in case the input voltage swings outside of the converter's range. Furthermore, similar to most electrical equipment with dimmable features, LED driver circuits may be equipped with their corresponding dimming components integral therein. Unfortunately, the dimming components are inoperable with external dimmers belonging to other electronic devices, hence they require their own corresponding external dimmers.

Conventional LED drivers and heat sinks are not readily adapted for existing light fixtures. Accordingly, placing LED lighting component with its circuitry inside lighting fixtures and other structures is challenging with various space constraints and electrical incompatibility. As a result, lighting fixtures utilizing LED light sources are not readily available in conventional lighting supply houses.

### SUMMARY

Accordingly, a need has arisen to provide a light emitting diode (LED), light device or “engine” that is compact, provides high power LED components and is able to be component replaceable with conventional lighting fixtures. In one embodiment the novel light engine contains a single board driver circuitry operable with high power LED components thereon, equipped with a heat sink as an integral part of the single board to dissipate the generated heat. The driver circuitry contains a converter for varying multiple allowable input voltages to a proper voltage within the operating range of the LED, an over voltage protection component for protecting the LED (and other circuitry) against voltages outside of their operating range and a dimming component adaptable to be operated with external dimming switches belonging to other devices. In another embodiment, the driver circuitry also contains a transformer to accept line voltage input.

Additionally, a need has arisen to provide the above functionality in a manner such that the compact light engine can be readily used in a light fixture. Additionally, a need has arisen to provide a cartridge for housing the light engine such that they can easily be integrated inside a conventional light fixture or removed from one. Moreover, a need has arisen to focus the light emanating from an LED such that the light may be focused, magnified and/or diffused by certain angles. It will become apparent to those skilled in the art after reading the detailed description of the present invention that the embodiments of the present invention satisfy the above mentioned needs.

In one embodiment of the present invention, an LED engine is described that is compact and operable in one embodiment for low voltage and/or another embodiment for high voltage applications. The light engine is operable using a single electronic board which contains high power LED components (e.g., 250-1000 mA at 3.2 v). The single board LED engine is equipped with a heat sink for dissipating the heat generated from the one or more LEDs. In one embodiment, the heat sink is formed as an integrated layer or multiple layers of nickel and silver plates of the single board (e.g., PCB board). In other embodiments, the heat sink may be formed by a plurality of vias on the single board wherein the vias allow air flow to dissipate heat.

Embodiments of the present invention include a light engine also having driver circuitry that contains a converter on the single board for accepting multiple input voltages and converting to a voltage within the operable range of the LED(s). The light engine further includes an over voltage protection component for preventing potential damage to the LED components or other circuitry present on the single board resultant from an input voltage outside of the operating range. Furthermore, in one embodiment a dimming component is used that is operable with an external dimming component belonging to other electronic devices. In line voltage applications, a power converter which may be a transformer is also present within the light engine.

As a result, a flexible, compact and universal light engine (on a single piece PCB board) is provided which is operable with multiple input voltages, and wherein its components are protected from input voltage swings outside of their normal operating range. Additionally, the light engine and its dimming component are provided with added flexibility to be operable with external dimming components belonging to other electronic devices. The light engine also has integrated compact heat dissipation.

The high power LEDs also provide excellent light output at 250 to 1000 mA at 3.2 volts. The high light output coupled with the compact design of the light engine make it an excellent choice as a high efficiency light source for most lighting fixtures. The lighting engine can be used to readily replace the light source for most conventional lighting fixtures, whether it be high voltage or low voltage applications.

More specifically, one embodiment of the present invention pertains to a lighting device including a single printed circuit board comprising an integrated heat sink for dissipating heat; a high power and high efficiency light emitting diode (LED), coupled to the printed circuit board, operable to emit light; and driver circuitry, coupled to the printed circuit board and further coupled to drive the high power and high efficiency LED, the drive circuitry capable of receiving multiple input voltages and supplying an appropriate power signal to drive the LED.

Embodiments include the above and wherein the driver circuitry includes over voltage protection circuitry for providing protection for the high efficiency LED due to inappropriate input voltages. Embodiments further include the above and wherein a transformer coupled to the printed circuit board operable to receive a line voltage input and supply a low voltage to the drive circuitry. Moreover, embodiments include the above and wherein the line voltage is substantially operable within the range of 90 to 260 v.

Furthermore, embodiments also include a buck-boost circuitry and substantially operable within 8 to 30V. In one embodiment the drive circuitry includes internal dimming circuitry operable to control the brightness of light output of the LED and further operable to allow an external dimming device to control the dimming function of the internal dimming component.

In one embodiment the heat sink includes a plurality of vias within said printed circuit board for allowing air flow to dissipate heat generated from the LED. In one embodiment the heat sink includes a combination of nickel and silver plate layers to dissipate heat generated from the LED. Embodiments include the above and wherein the high efficiency LED is operable substantially between 250 mA to 1 A at 3.2 v and produces at least 55 lumens.

In one embodiment, the light engine may include a plurality of LED components. Moreover, in other embodiments, the light engine may include a plurality of LED driver circuitries. Embodiments include the above and wherein the plurality of LED components is controlled independently with the plurality of LED driver circuitries.

### BRIEF DESCRIPTION OF THE DRAWINGS

FIG. 1 shows an exemplary light engine block diagram in accordance with one embodiment of the present invention.

FIG. 2 shows a single light engine having a printed circuit board with an LED in accordance with one embodiment of the present invention.

FIG. 3A shows a light engine having a single printed circuit board with three LED components in accordance with one embodiment of the present invention.

FIG. 3B shows a light engine having a single printed circuit board with nine LED components in accordance with one embodiment of the present invention.

FIG. 3C shows a light engine having a single printed circuit board with twelve LED components in accordance with one embodiment of the present invention.

FIG. 3D shows a light engine having a single printed circuit board with thirty six LED components in accordance with one embodiment of the present invention.

FIG. 3E shows a light engine having a single printed circuit board with nine LED components independently controlled by three LED drivers in accordance with one embodiment of the present invention.

FIG. 4 shows a cross section of a PCB board comprising an integrated heat sink in accordance with one embodiment of the present invention.

FIG. 5 shows a cross section view of a PCB board comprising an integrated heat sink in accordance with one embodiment of the present invention.

FIG. 6A shows an exemplary light engine driver circuit having a line input voltage in accordance with one embodiment of the present invention.

FIG. 6B shows an exemplary generic light engine driver circuit having a DC input voltage in accordance with one embodiment of the present invention.

FIG. 6C shows an exemplary light engine driver circuit having a low DC input voltage with a buck converter in accordance with one embodiment of the present invention.

FIG. 6D shows an exemplary light engine driver circuit having a low DC input voltage with a buck-boost converter in accordance with one embodiment of the present invention.

FIG. 7 shows an optic for a one LED light engine in accordance with one embodiment of the present invention.

FIGS. 8A and 8B show a side and a top view of optics for a three LED light engine in accordance with one embodiment of the present invention.

FIGS. 9A and 9B show a top and a bottom portion of a cartridge for housing a single piece LED light engine in accordance with one embodiment of the present invention.

FIG. 10A shows the cartridge of FIGS. 9A and 9B housing a single piece LED light engine and an optic in accordance with one embodiment of the present invention.

FIG. 10B shows the cartridge of FIG. 9A and 9B housing a single piece LED light engine and an optic for narrow lighting fixture application in accordance with one embodiment of the present invention.

FIG. 10C shows a light engine strip in accordance with one embodiment of the present invention.

FIGS. 11A and 11B show a top and bottom portion of a fixture housing the encapsulated LED circuit board of FIG. 10 forming a replaceable can in accordance with one embodiment of the present invention.

FIG. 12 shows a directional flood, e.g., landscape, light fixture for housing a cartridge that houses the LED light engine of FIG. 10 in accordance with one embodiment of the present invention.

FIG. 13 shows a two sided light fixture for housing a cartridge that houses the LED engine in accordance with one embodiment of the present invention.

FIG. 14 shows a light fixture for housing the LED engine for lighting the water flowing from one side of the fixture in accordance with an embodiment of the present invention.

FIG. 15 shows a puck light fixture for housing the LED engine for lighting underneath cabinets in accordance with an embodiment of the present invention.

### DETAILED DESCRIPTION

Reference will now be made in detail to embodiments of the present invention, examples of which are illustrated in the accompanying drawings. While the invention will be described in conjunction with these embodiments, it will be understood that they are not intended to limit the invention to these embodiments. On the contrary, the invention is intended to cover alternative, modifications and equivalents, which may be included within the spirit and scope of the invention as defined by the appended claims. Furthermore, in the following detailed description of the present invention, numerous specific details are set forth in order to provide a thorough understanding of the present invention. However, it will be evident to one ordinary skill in the art that the present invention may be practiced without these specific details. In other instances, well known methods, procedures, components, and circuits have not been described in detail as not to unnecessarily obscure aspects of the invention.

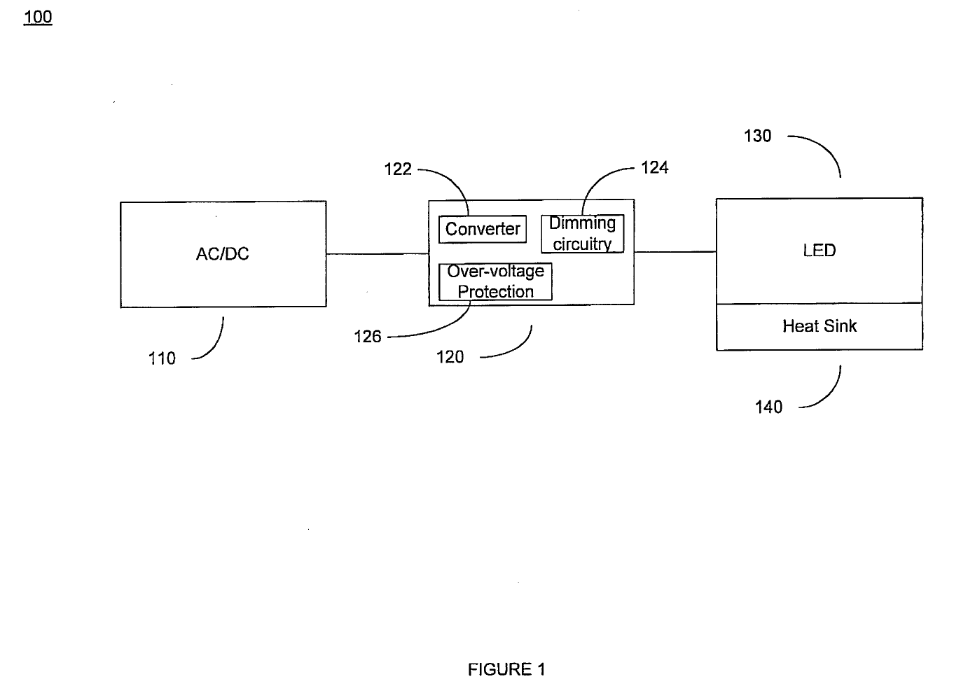

Referring now to FIG. 1, an exemplary light engine block diagram 100 in accordance with one embodiment of the present invention is shown. The block diagram comprises an AC/DC block 110 coupled to a driver circuitry 120 which is further coupled to at least one light emitting diode (LED) component 130 with a heat sink 140. The AC/DC block 110 is optional and may be used to convert alternating current (AC) to a direct current (DC) in embodiments that accept line-voltage input. In one embodiment, the AC/DC block 110 may be a rectifier to provide low voltage from a line voltage input. AC/DC block 110 is coupled to the driver circuitry 120. It is appreciated that in other embodiments the AC/DC block 110 may be formed as an integral part of the driver circuitry 120.

The driver circuitry 120 may be used to convert the input voltage to an appropriate voltage for the LED (e.g., by using a power converter). The functional unit for converting is depicted as unit 122. As such, the driver circuitry 120 may step-up or step-down the input voltage such that the appropriate voltage is supplied to the LED component 130. For example, the power converter may accept multiple input voltages (e.g., 90-260 volts) and convert the input voltage to 3.2 volts, the operating voltage of the LED component 130 according to one embodiment of the present invention.

Moreover, the driver circuitry 120 may provide over-voltage protection. Accordingly, over-voltage protection circuitry protects the LED component 130 such that the LED component 130 is protected against input voltage swings outside of the power converter range. The functional unit for over-voltage protection is depicted as unit 126. For example, if the power converter is operable between 90-260 volts and an input voltage of 280 volts is applied, the over-voltage protection circuitry disables the circuit in order to protect the driver circuitry 120 and the LED component 130. In one embodiment, the driver circuitry 120 is capable of providing the LED component 130 with a universal dimming functionality. The universal dimming function of the driver circuitry 120 is capable of being used with any external dimming components belonging to other devices. The dimming functionality of the driver circuitry 120 is shown by the functional unit 124. As such, conventionally installed external dimmers may be used.

The driver circuitry 120 is coupled to the LED component 130. The LED component 130 in one example may be a high brightness LED with efficiency of at least 90% and operable at a few milliamps to more than 1 A and produces up to 110 lumens with a lifespan of 50,000 hours to 100,000 hours. In one embodiment of the present invention, the LED 130 used is a K2 LED model manufactured by Lumileds Inc. In one embodiment of the present invention, the LED 130 operates at 350 mA at 3.2 volts and produces at least 55 lumens. One advantage of using LED technology is that it requires 5-10 times less power over conventional light while producing more lumens in comparison to other light producing devices (e.g., a fluorescent light).

Referring still to FIG. 1, the LED component 130 is coupled to a heat sink 140. The heat sink 140 is used to dissipate heat that is generated by the LED component 130. Since LED 130 generates heat it can damage the driver circuitry 120 or the LED 130 if not addressed. Accordingly, the heat sink 140 is physically coupled to the LED component 130 to transfer and to dissipate heat away from the LED component 130. It is appreciated that the heat sink 140 may also be coupled to the driver circuitry 120 (not shown). It is appreciated that in one embodiment of the present invention the heat sink 140 is integrated into the printed circuit board (PCB) on which the LED component is attached. However, it is also appreciated that a heat sink separate from but proximate to the PCB board may be used.

In one embodiment of the present invention, the heat sink 140 comprises a nickel silver plate layer. The heat sink 140 may also comprise good thermal conductors such as copper or aluminum alloy. Accordingly, the nickel silver plate or other similar alloys act to transfer and to dissipate heat from the LED component 130. In one embodiment, the heat sink layer 140 may comprise a plurality of vias (e.g., holes) such that airflow can effectively transfer the heat away from driver circuitry 120 and the LED component 130. In another embodiment of the present invention, a plurality of vias is used, allowing airflow to transfer and to dissipate heat in conjunction with using the nickel silver plate layer. It is appreciated that even though that in one embodiment a nickel silver plate layer is used as a heat sink, other metals and alloys may be similarly be used. Accordingly, the use of nickel silver plate layer is exemplary and should not be construed limiting. It is also appreciated that more than one layer of nickel silver plate or other similar alloys may be used.

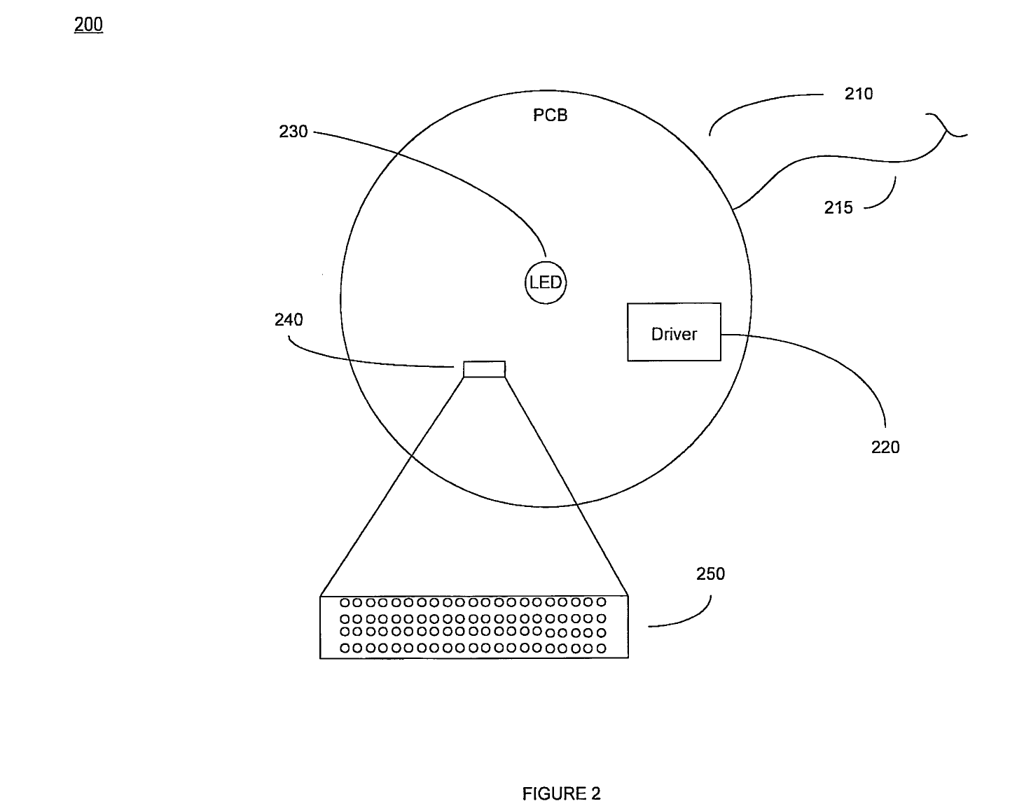

Referring now to FIG. 2, a top view a light engine having a single printed circuit board (PCB) with an LED component in accordance with one embodiment of the present invention is shown. The light engine 200 in accordance with one embodiment of the present invention includes an LED component 230 and driver circuitry 220 on a single PCB board 210 comprising a heat sink 240 integrated therein. Input voltage is supplied via line 215.

The driver circuitry 220, coupled to the PCB 210, includes an integrated circuit and one or more surface mounted passive components and may receive an input voltage (e.g., a line voltage between 90-260 v). The driver circuitry 220 may have a transformer for transforming the AC to a DC in addition to stepping-up or stepping-down the input voltage to an appropriate voltage within the operating voltage of the LED component 230 (e.g., 3.2 volts). For example, the step-up or step-down operation may be performed using a transformer or a voltage converter housed within the driver circuitry 220 or separate from the driver circuitry 220. For example, in one embodiment, the driver circuitry 220 is capable of accepting multiple input voltages (e.g., 90-260v) and converting it to an appropriate DC voltage for the LED 230 (e.g., 3.2 volts at 250 to 1000 mA). In embodiments that accept low voltage input only, the AC to DC conversion is not required.

In one embodiment, the driver circuitry 220 is further equipped with internal over-voltage protection circuitry. The integrated over-voltage protection circuitry disconnects the light engine 200 if the input voltage is outside of the operating range of the LED component 230. The over-voltage protection circuitry may be used to protect the LED component 230 from voltage swings outside of the light engine's 200 operating range. For example, in one embodiment if the input voltage is above 260 v, the over-voltage protection detects that the input voltage is outside of its operating range and disconnects the light engine 200 to protect the LED component 230. It is appreciated that if a converter is not used, the over-voltage protection circuitry disconnects the light engine 200 if it detects the input voltage to be outside of the operating range of the LED component 230.

In one embodiment of the present invention, the driver circuitry 220 is further equipped with an integrated dimming circuitry. The integrated dimming circuitry controls the brightness of the LED component 230. In one embodiment, the dimming circuitry is a universal dimming circuitry such that it is operable with any external dimming component belonging to other electronic devices. As such, the need to replace external dimming components belonging to other electronic devices is eliminated. It is appreciated that over voltage-protection circuitry, the dimming circuitry and the converter discussed above may be implemented within the driver circuitry 220.

Referring still to FIG. 2, the driver circuitry 220 is coupled to the PCB 210 and further coupled to the LED component 230. The driver circuitry 220 converts the input voltage to the operating voltage for the LED component 230. As discussed above, the LED component 230 may be a K2 LED model manufactured by Lumileds Inc. In one embodiment, the LED 230 is operable from a few milliamps to over 1 amp. In one preferred embodiment, the LED component 230 is operable at 350 mA and produces at least 55 lumens.

The LED component 230 may generate considerable amount of heat that if not addressed can damage the LED component 230 and other electronic circuitries. Accordingly, a heat sink 240 is used to dissipate and to transfer heat generated by the LED component 230. In one embodiment, the heat sink 240 is integrated within the PCB and comprises a plurality of vias 250. The plurality of vias 250 may be distributed uniformly over the surface area of the PCB 210.

It is appreciated that the plurality of vias 250 may completely extend through the thickness of the PCB 210 from one end to another end or they may be vias that partially extend through the PCB 210. The plurality of vias 250 is operable to dissipate heat by the virtue of their openings. The plurality of vias 250 that completely extend through the PCB 210 enable airflow through the PCB 210. Accordingly, the airflow through transfers and dissipates the generated heat away from the PCB 210 and other electronic components on the PCB 210 (e.g., the LED 230). As such, the PCB 210 and other electronic components on the PCB 210 (e.g., the LED 230 and the driver circuitry 220) are cooled. It is appreciated that various methods may be employed to design the heat sink 240. For example, a combination of metal alloys may be used as heat transfer, which is discussed in more detail below.

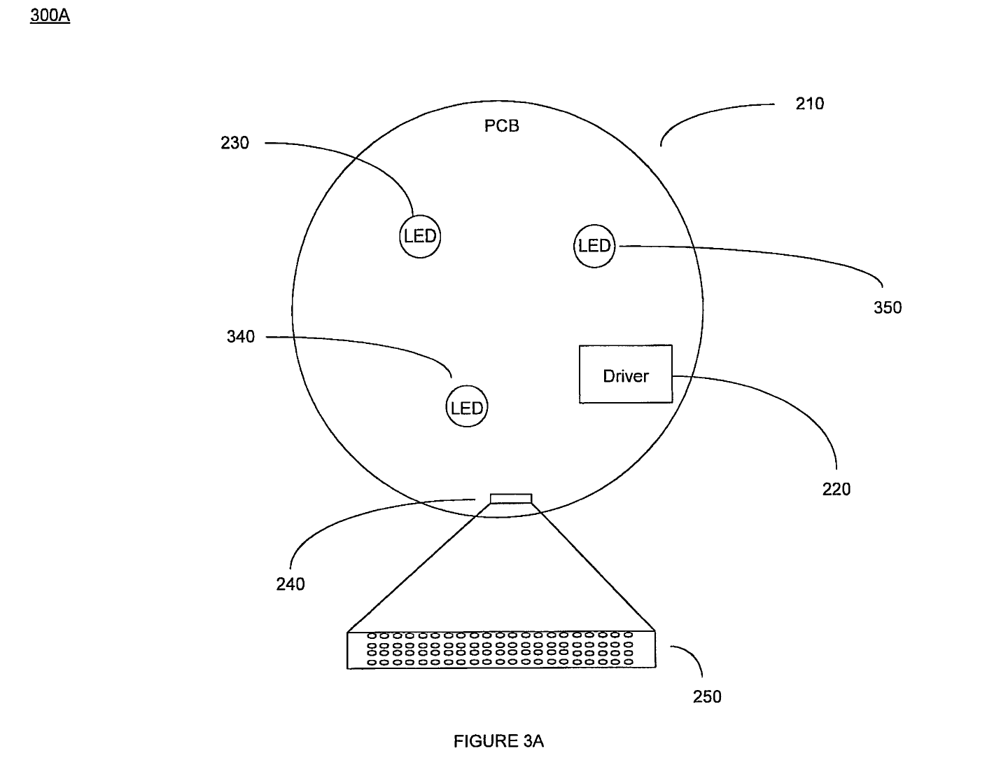

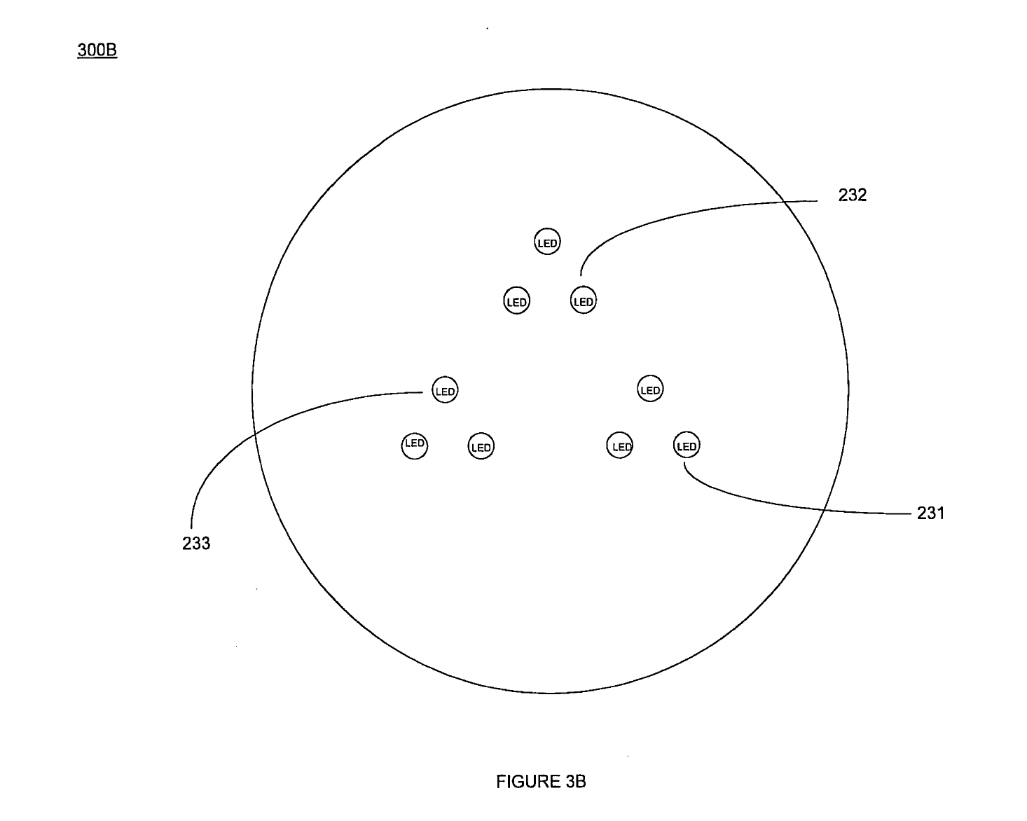

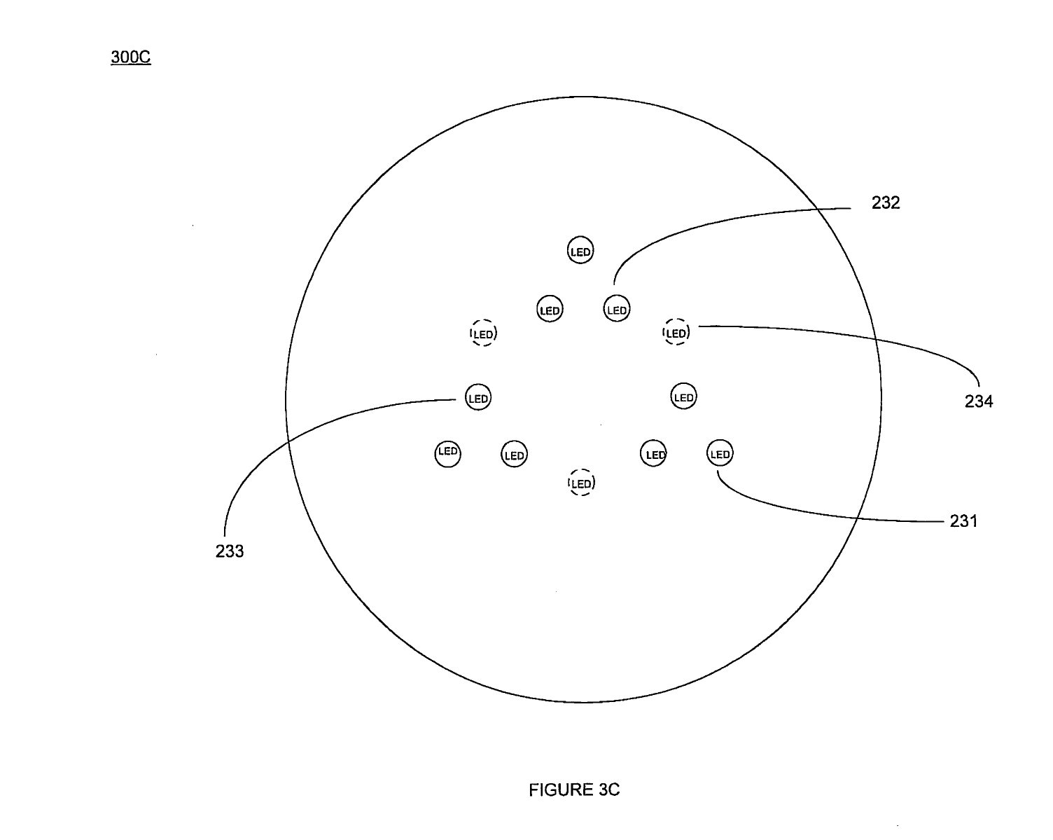

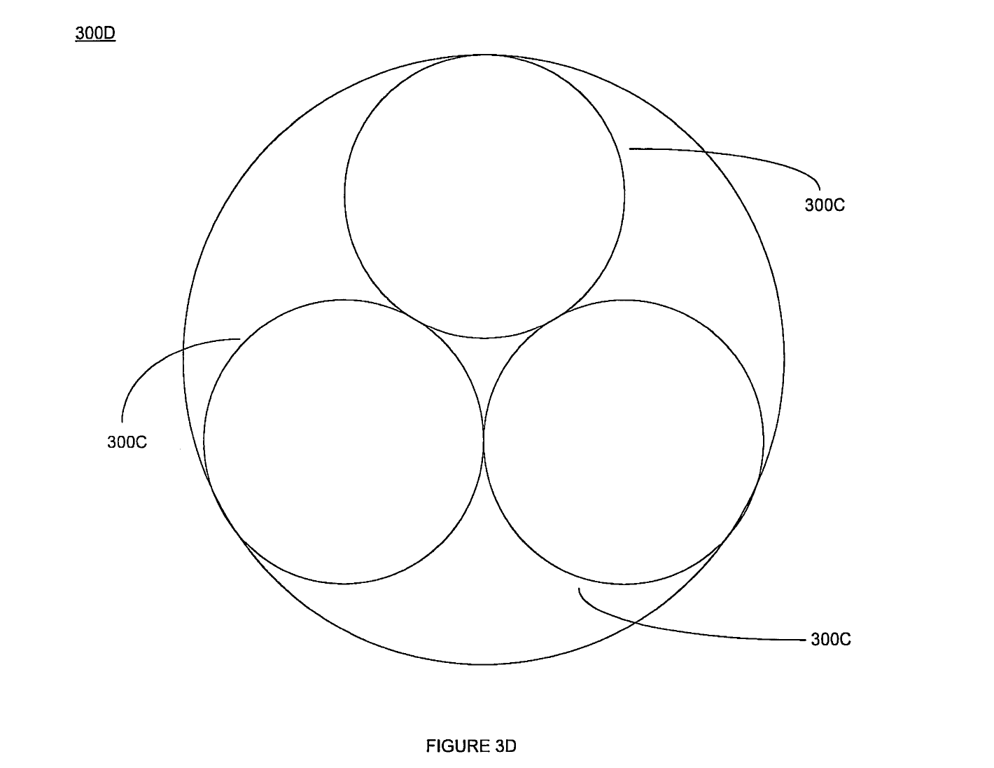

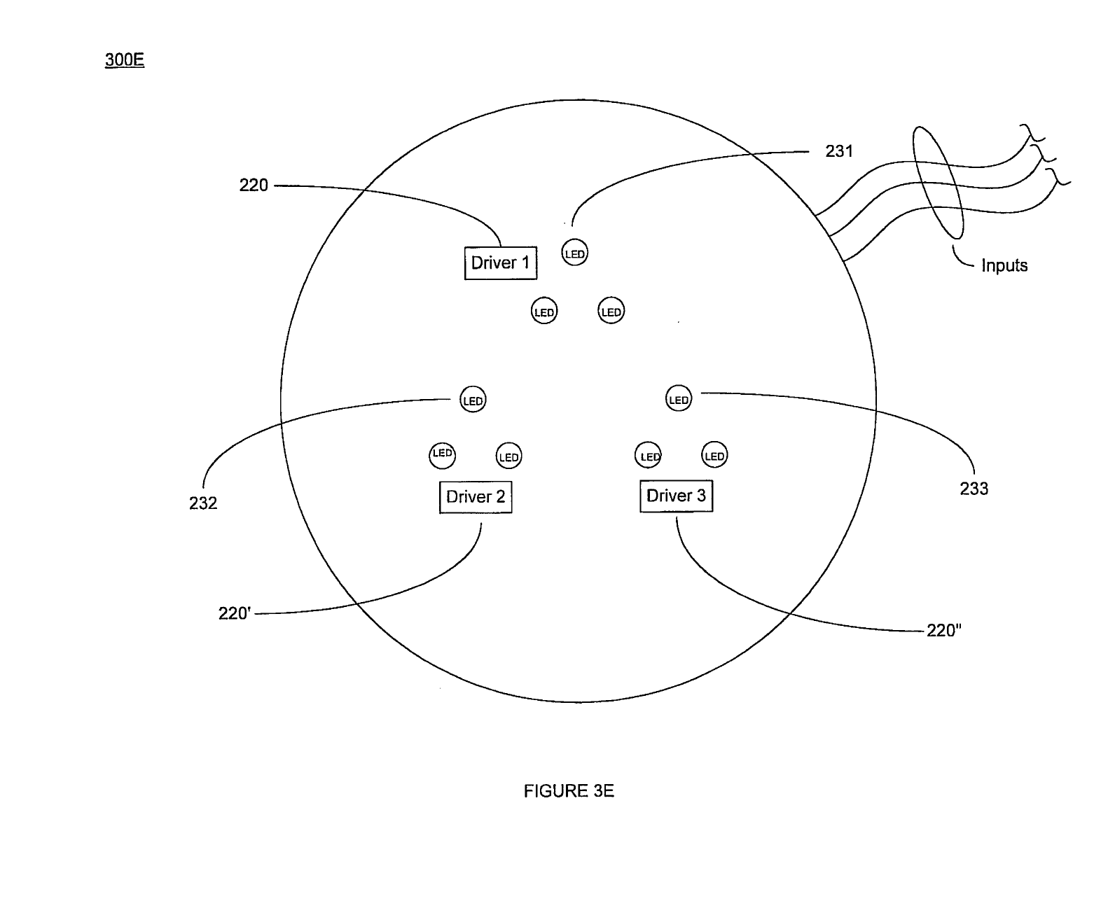

Referring now to FIG. 3A, a light engine 300A having its components housed within a single PCB with three LED components in accordance with one embodiment of the present invention is shown. In addition to the electronic components described in FIG. 2, the light engine 300A further comprises two additional LED components, LED 340 and LED 350 situated uniformly across the surface area of the PCB, the LEDs may be of the same or different color. In this embodiment, the LEDs 230, 340 and 350 are controlled by the same driver circuitry 220. It is appreciated that in one embodiment the LED components 230, 340 and 350 are equally spaced on the PCB board 210 such that they form an even light array when they are turned on.

It is appreciated, however, that each LED component may be controlled independently with its own corresponding driver circuitry (not shown). It is further appreciated that even though three LED components are shown, the light engine may comprise additional LED components. For example, the light engine 300A may comprise six LED components (not shown), nine LED components (not shown), twelve LED components (not shown) and thirty six LED components (not shown). It is further appreciated, that the number of LED components may be extended to any number of LED components. Accordingly, it is appreciated that the number of LED components shown is exemplary and should not be construed limiting. It is also appreciated that the LED components may be tinted and be of different colors (e.g., red, blue and green) where each color is capable of being controlled by its corresponding driver circuitry in the above case having independent control. In the case of independent control, each separate driver circuit requires its own input voltage supply line.

Referring now to FIG. 3B, a light engine 300B having its components housed within a single printed circuit board with nine LED components in accordance with one embodiment of the present invention is shown. It is appreciated that the driver circuitry and the heat sink are included but not shown. In this embodiment, nine LED components are used. In this embodiment, three groups containing three LED components 231, 232 and 233 are equally spaced on the PCB board. It is appreciated that in one embodiment each group 231, 232 and 233 contains three LED components. It is also appreciated that in one embodiment the three LED components in each group are equally spaced on the PCB such that when the LED components are turned on they form a uniform light array. It is further appreciated that the LED components and/or groups may be controlled by a single driver circuit as described above or may have their own corresponding driver circuitry. In independent control, each group may be independently controlled or each respective light in all groups may be independently controlled. Using the latter, each LED of a group may be of a different color e.g., red, green, blue.

Referring now to FIG. 3C, a light engine 300C having its components housed within a single printed circuit board with twelve LED components in accordance with one embodiment of the present invention is shown. It is appreciated that in one embodiment, nine LED components may be formed into three groups 231, 232 and 233 as discussed above with respect to FIG. 3B. It is also appreciated that the three groups 231, 232 and 233 are equally spaced on the PCB board wherein each group containing three LED components are also equally spaced within the same group. In this embodiment, the tenth, the eleventh and the twelfth LED components may be formed into a fourth group 234 and shown by dash lines. It is appreciated that according to one embodiment the fourth group 234 containing three LED components are inter-dispersed equally between the first three groups 231, 232 and 233 such that when LED components are turned on they form a uniform light array.

It is appreciated that in one embodiment, the LED components and/or groups may have different colors (e.g., red, blue and green) and may be separately controlled. It is further appreciated that the LED components and/or groups may be controlled by a single driver circuit as described above or may have their own corresponding driver circuitry and input voltage line.

Referring now to FIG. 3D, a light engine 300D having its component mounted on a single printed circuit board with thirty six LED components in accordance with one embodiment of the present invention is shown. The light engine 300D comprises three groups 300C, each containing twelve LED components. It is appreciated that each group 300C may be implemented as described above in FIG. 3C. It is also appreciated that each group 300C may be equally spaced on the PCB board such that when the LED components are turned on they form a single uniform light array. Similar to above, the LED components may have different colors (e.g., red, green and blue). It is further appreciated that the LED components and/or groups 300C may be controlled by a single driver circuit as described above or may have their own corresponding driver circuit.

Referring now to FIG. 3E, a light engine 300E having its components housed within a single printed circuit board with nine LED components independently controlled by three LED drivers in accordance with one embodiment of the present invention is shown. It is appreciated that the light engine 300E is capable of receiving multiple voltage inputs, provides for dimming functionality, provides over-voltage protection and dissipates heat away from the light engine as described above. The light engine 300E according to one embodiment contains nine LED components formed into three groups 231, 232 and 233. According to one embodiment, each group 231, 232 and 233 or each respective LED in all groups is controlled by a separate driver circuitry. For example, group 231 is controlled by driver circuitry 220, group 232 is controlled by driver circuitry 220′ and group 233 is controlled by driver circuitry 220″. Alternatively, the first LED in all groups or the second LED in all groups or the third LED in all groups can be separately controlled.

It is appreciated that the design may be extended to where each LED component is controlled by a separate driver circuitry. Controlling each group/LED component with a separate driver circuitry may be used in lighting effect. For example, LED components may be of different colors (e.g., red, blue and green) and each LED component being controlled by a separate driver may be programmed such that a different light color is turned on separately via separate voltage input lines.

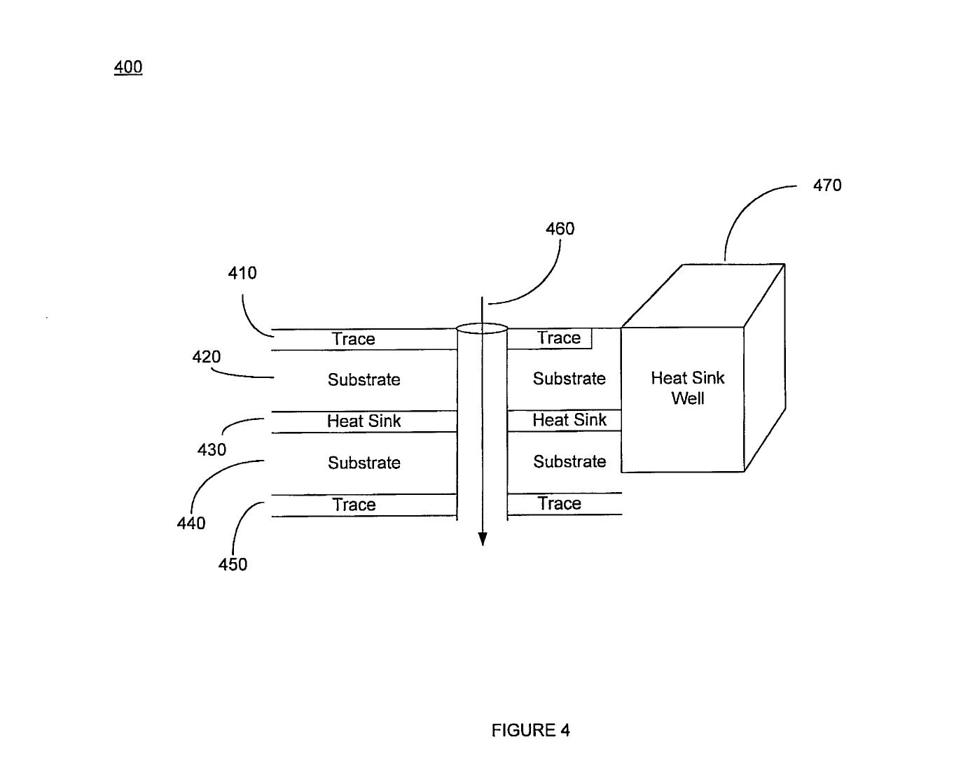

Referring now to FIG. 4, a cross section of a PCB board 400 comprising an integrated heat sink in accordance with one embodiment of the present invention is shown. This heat sink can be used with any of the light engine embodiments discussed herein. A typical PCB board comprises trace layers on the surface of the PCB for providing a mean for connecting various electronic components. It is appreciated that trace layers may be on one side of the PCB board or on both sides of the PCB board as shown by trace layers 410 and 450.

In general PCB boards further comprise a substrate layer. For example, epoxy resin is commonly used in forming one or more substrate layers. The heat sink 400 in accordance with one embodiment of the present invention may use two layers of substrate 420 and 440. However, it is appreciated that any number of substrate layers may be used. It is further appreciated that the use of two substrate layers in the PCB board 400 is exemplary and should not be construed limiting.

Referring still to FIG. 4, the PCB board 400 further comprises a heat sink layer 430. In one embodiment, the heat sink layer 430 may be a nickel silver plate layer. It is appreciated that other similar thermal conductors such as copper or aluminum alloy may be used. As such, the heat sink layer 430 may be used to transfer and dissipate heat away from the LED component and the light engine generally. It is further appreciated that the PCB board 400 may further comprise additional heat sink/substrate layers or it may use fewer layers than what is presented. It is also appreciated that the thickness of the layers may vary. Accordingly, each layer may be uniform or non-uniform with varying thickness.

In one embodiment, the heat sink comprises via 460 which may extend through the PCB board 400. The via 460 may extend through from one side of the PCB to another side of the PCB board. Accordingly, air flows from one side of a PCB board to another side of the PCB board. In this embodiment, the via 460 is adjacent to the heat sink layer 430. Accordingly, heat is transferred by the heat sink layer 430 and is dissipated using the air flow through the via hole 460. It is appreciated that the via 460 may be a partial or complete connecting one side of the PCB board 400 to another side.

It is further appreciated that a heat sink well 470 may also be used. For example, the heat sink well 470 may be coupled to various layers of the PCB board 400. In this example, the heat sink well 470 is coupled to the surface of the PCB board 400. The heat sink well 470 is also coupled to the substrate layer 420, heat sink layer 430 and partially coupled to the substrate layer 440. It is appreciated that the heat sink well 470 may be coupled to both sides of the PCB board. It is further appreciated that the depth of the heat sink well 470 may vary. As such, the heat sink well 470 may be coupled to some layers and not others. It is therefore appreciated that coupling of the heat sink well 470 to the substrate layer 420, the heat sink layer 430, and partially to the substrate layer 440 is exemplary and should not be construed limiting.

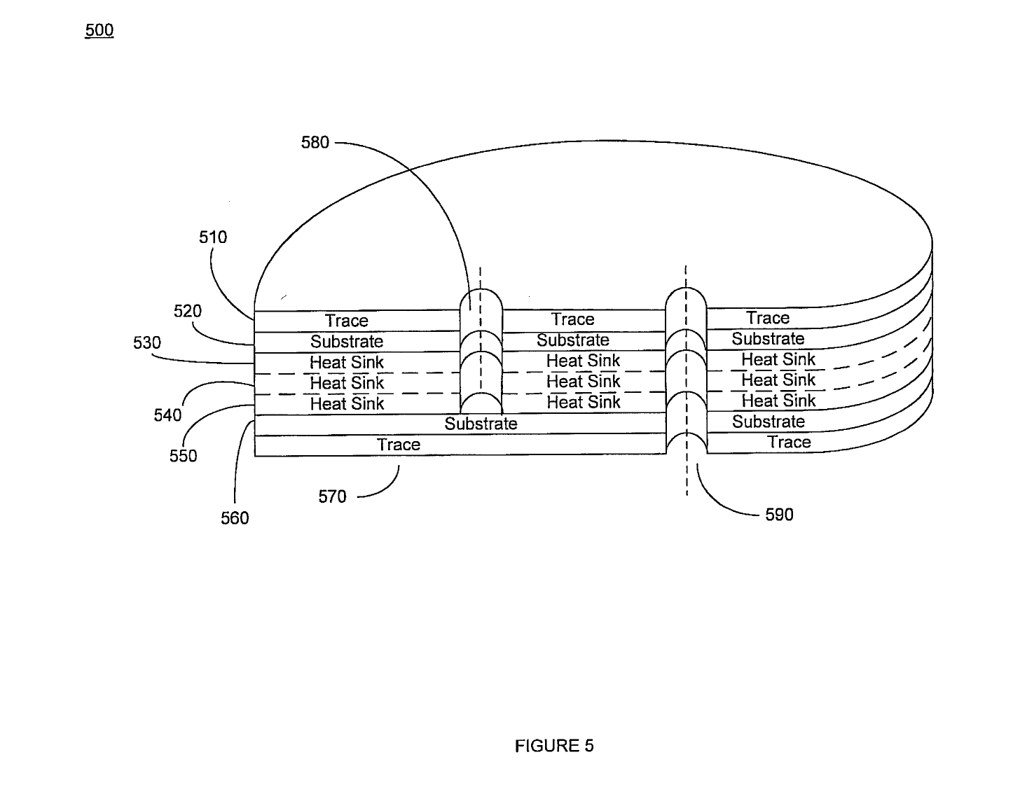

Referring now to FIG. 5, a cross sectional view of a PCB board 500 comprising an integrated heat sink in accordance with one embodiment of the present invention is shown. The PCB board 500 comprises a plurality of layers including trace layers 510 and 570, substrate layers 520 and 560, and various heat sink layers including heat sink layers 530, 540 and 550. Trace layers may be formed on the surface of the PCB for connecting various electronic components together. It is appreciated that trace layers may be on one side of the PCB board or on both sides of the PCB board as shown by trace layers 510 and 570. Trace layers are usually made from conductive material such that electrical connection between electronic components can be established. For example, copper may be used for trace layers 510 and 570.

Adjacent to the trace layers 510 and 570 may reside the substrate layers 520 and 560. As discussed above, most PCB boards use epoxy resin as their substrate layer. In this embodiment, three layers of heat sink 530, 540 and 550 may be used. The heat sink layers comprise thermal conductors. For example, heat sink layers may comprise copper, nickel, or silver plate layers or any combination thereof. It is appreciated that heat sink layers 530, 540 and 550 may comprise the same material or different material. It is also appreciated that the number of heat sink layers may vary. It is further appreciated that the thickness of the layers, including the heat sink layers may vary. Accordingly, the layers may have different thickness and they may be uniformly or non-uniformly distributed. It is also appreciated that even though the heat sink layers 530, 540 and 550 are shown adjacent to one another they may also be separated by other layers (e.g., substrate layer). As such, three adjacent heat sink layers 530, 540 and 550 is not intended to limit the scope of the embodiments of the present invention.

The heat sink layers 530, 540 and 550 are capable of distributing the generated heat over one or more layers and dissipating the generated to the surrounding environment. For example, heat may be transferred over the heat sink layer 530 to via 590 through the PCB board 500. Accordingly, the generated heat may be transferred using the heat sink layer 530 to the via 590 and dissipated to the surrounding environment by allowing the air flow through the via 590.

Referring still to FIG. 5, the heat sink may further comprise a plurality of vias, 580 and 590 for allowing the generated heat to be dissipated. In one embodiment, the via 580 is a partial. It is appreciated that the via 590 may extend through the PCB board 500 from one side to another side in order to allow air flow from one side to another. Accordingly, the air flow can dissipate the heat out to the surrounding environment, cooling the PCB board 500 as a result. It is appreciated that the depth of the partial via 580 may vary. Accordingly, it is appreciated that the depth of the via 580 that ends at the heat sink layer 550 is exemplary and should not be construed limiting. As such, the depth of the partial via 580 may be up to heat sink layer 540 or any other layer. It is further appreciated that even though one partial via 580 and one complete via 590 is shown, any number of partial or complete vias may be employed.

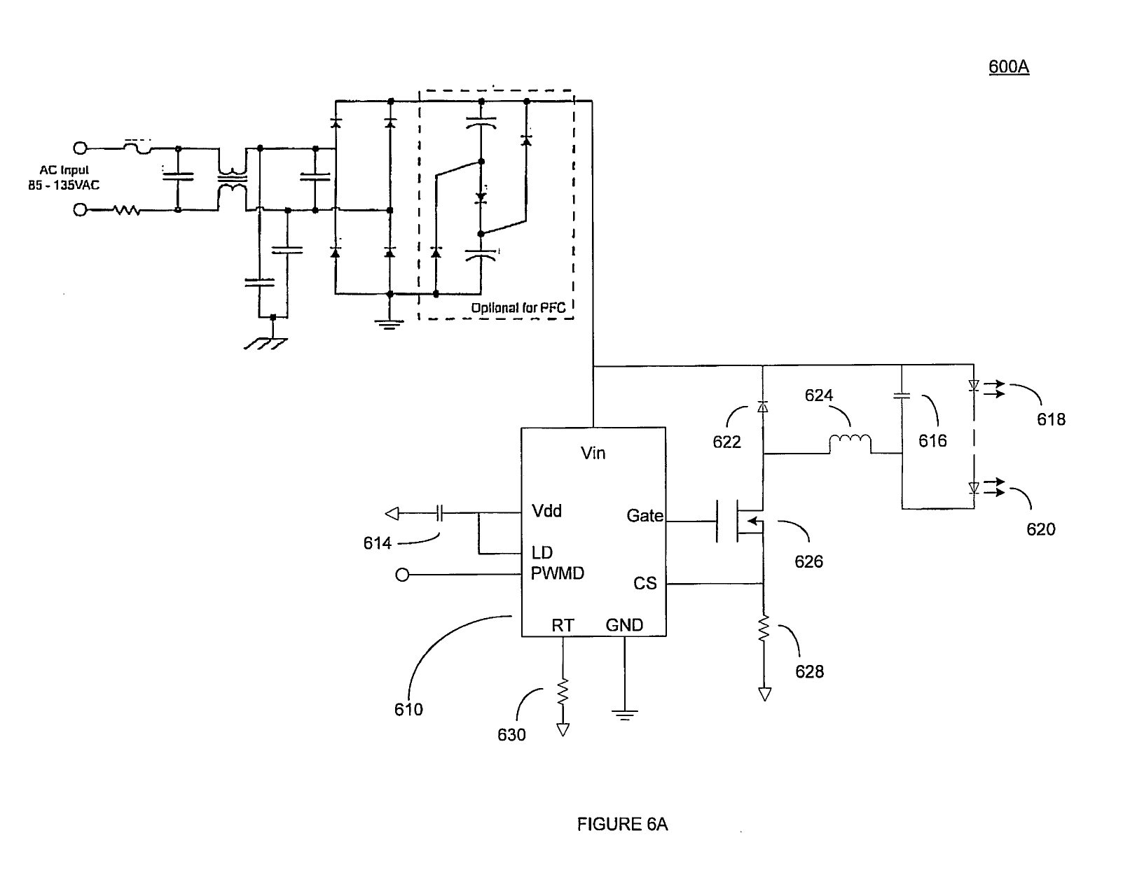

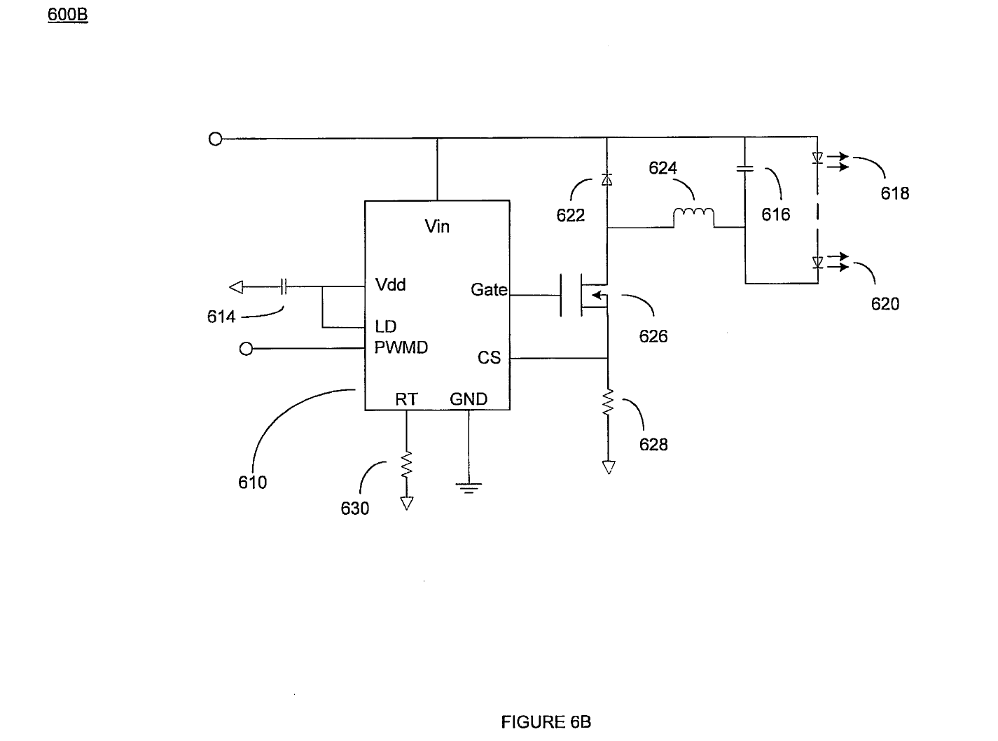

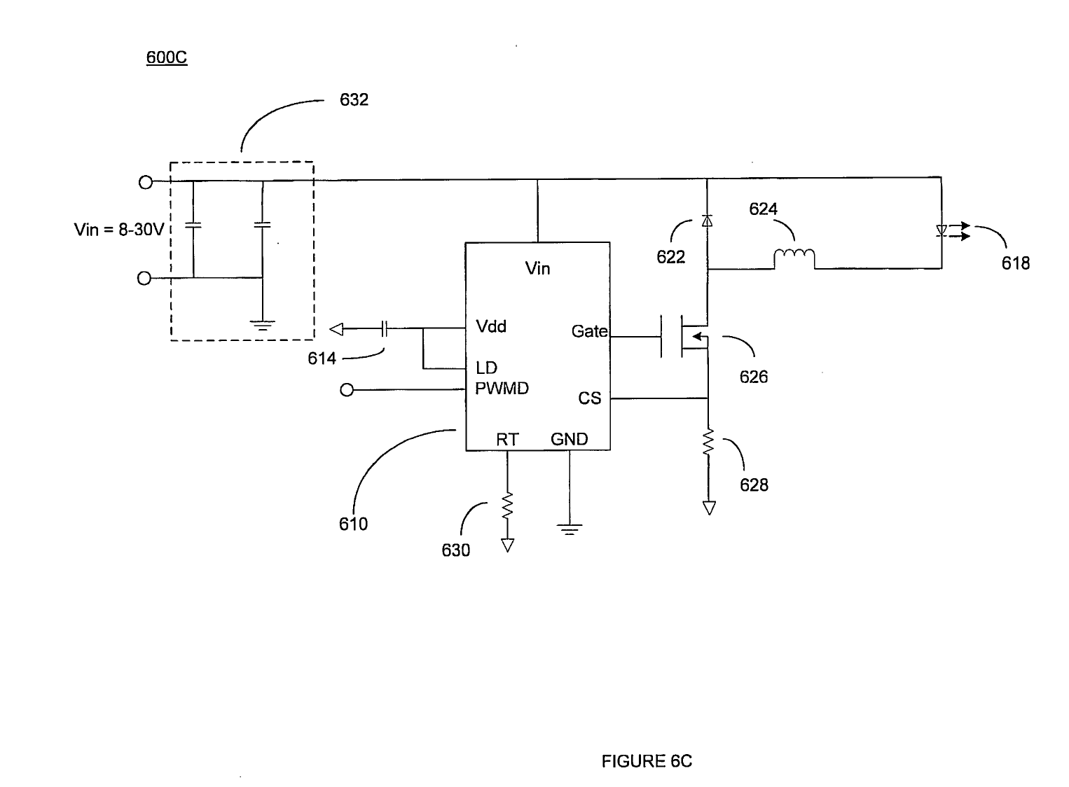

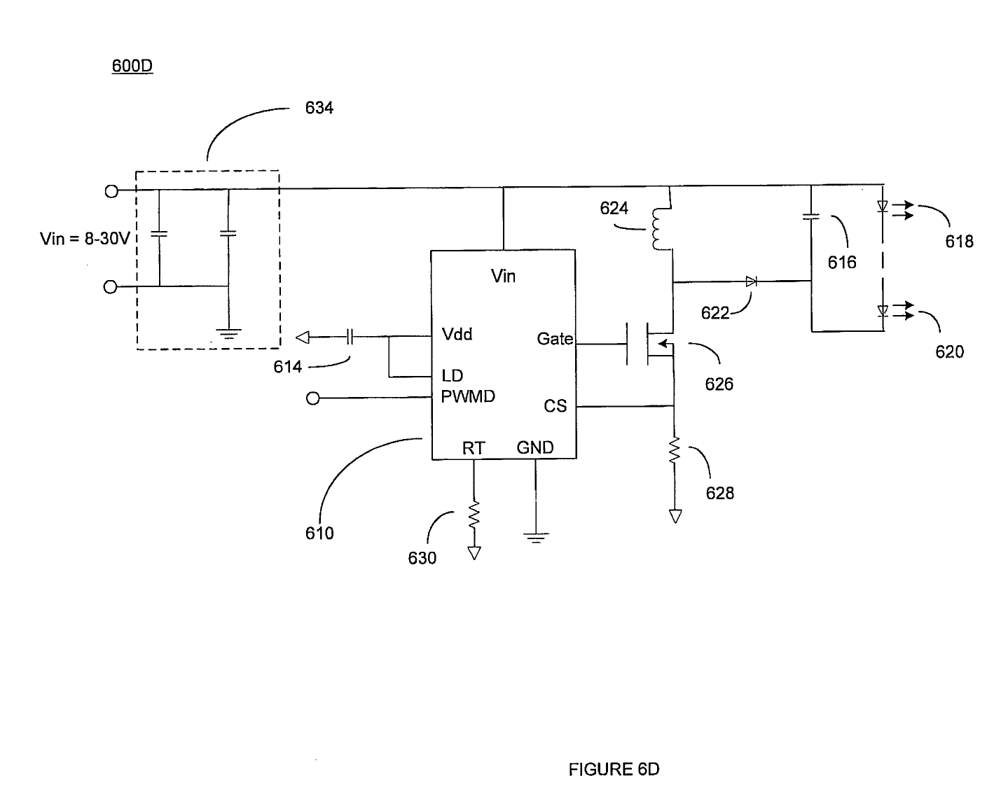

Referring now to FIG. 6A, an exemplary light engine driver circuit 600A having a line input voltage in accordance with one embodiment of the present invention is shown. The light engine driver circuit 600A comprises an integrated circuit chip 610 coupled to a plurality of LED components 618 and 620. The light engine driver circuit 600A further comprises additional electronic component that will be described below. The integrated circuit 610 in one embodiment is a HV9910 chip and can be purchased from Supertex Inc. of Sunnyvale, Calif. 94089.

In one embodiment, the integrated circuit chip 610 is a pulse width modulation LED driver control integrated circuit (IC). In this embodiment a converter circuitry may be used to convert a universal line voltage input to a DC voltage in order to operate the integrated circuit chip 610. A rugged high voltage junction may be used such that an input voltage surge of up to 450 v is tolerated. In one embodiment an optional passive power factor correction circuit can be added to pass the AC harmonic limits for equipment having input power of less than 25 W. In one embodiment, an input filter capacitor is used to hold the rectified AC voltage above twice the plurality of LED components 618 and 620 throughout the AC line cycle. It is appreciated that the input line voltage 85-135 voltage AC is exemplary and should not be construed limiting. For example, in other embodiments a wider input voltage may be used (e.g., 90-260 volt AC).

In one embodiment, to provide a flexibility of being operable with a universal AC line a converter may be used to step-up or step-down the input voltage to a desired level. The converter may be a transformer in one embodiment that may be implemented within the integrated circuit chip 610 or alternatively it may be implemented outside of the integrated circuit chip 610.

In one embodiment, the plurality of LED components 618 and 620 coupled to the integrated circuit chip 610 are driven at a constant current. Accordingly, the light output is constant, the reliability is enhanced and the lifespan of the plurality of LED components 618 and 620 is increased as comparison to operating the plurality of LED components 618 and 620 at a constant voltage. In this embodiment, the output current is programmed between a few milliamps to more than 1 A.

It is appreciated that although the plurality of LED components 618 and 620 are shown to be coupled in series, the configuration should not be construed as limiting. Accordingly, the plurality of LED components 618 and 620 may be coupled in parallel, series or combination thereof.

In one embodiment, the integrated circuit chip 610 controls all basic types of converters. Accordingly, a gate signal coupled to the MOSFET transistor 626 may be used to enhance the power, such that integrated circuit chip 610 stores the input energy in the inductor 624 coupled to the integrated circuit chip 610 that may partially deliver energy to the plurality of LED components 618 and 620. Accordingly, the energy stored in the magnetic component is delivered to the plurality of LED components 618 and 620 during the off-cycle of the power MOSFET 626, which produces current through the plurality of LED components 618 and 620. In one embodiment, the integrated circuit chip 610 controls the external MOSFET transistor 626 at a fixed frequency of up to 300 kHz through the gate pin of the integrated circuit chip 610. In one embodiment, the frequency can be programmed by using a resistor 630. It is appreciated that in one embodiment the value of the inductor 624 is designed such that the plurality of LED components 618 and 620 receive a constant current. In one preferred embodiment, the inductor 624 is designed such that the plurality of LED components 618 and 620 receive approximately 350 mA.

In one embodiment, when the voltage at V_{dd} pin exceeds the ultra-voltage lockout threshold, the gate is enabled. In this embodiment, the output current is controlled by limiting peak current in the external power MOSFET 626. A resistor 628 may be used as a current sense resistor. Accordingly, the MOSFET 626 is turned off when the voltage at the CS pin exceeds a peak current sense voltage threshold by terminating the gate drive signal. In this embodiment, the threshold is set at 250 mV. Alternatively, the threshold may be programmed externally by applying a voltage to the LD pin. Additionally, a diode 622 may be used for added stability in the circuit and for protection against voltage swings.

In embodiments that soft start is required, a capacitor 614 may be used to allow the voltage to ramp at a desired rate. Accordingly, the output current to the plurality of LED components 618 and 620 ramp gradually, preventing the LED components from being damaged. Alternatively, a passive power factor correction circuit may be utilized (not shown) for ramping up gradually.

In one embodiment, the peak CS voltage is a good approximation of the current in the plurality of LED components 618 and 620. However, there is a small error associated with this current sensing method which is introduced by the difference between the peak and the average current in the inductor 624. The small error may be compensated for by introducing a resistive component which may be the same as the current sensing resistor 628.

The integrated circuit chip 610 is capable of dimming and varying the brightness of the plurality of LED components 618 and 620. Dimming may be accomplished by varying the duty ratio of the pulse width modulation pin such that the brightness of the plurality of LED components 618 and 620 can be controlled. In one embodiment, the low frequency pulse width modulation signal has a duty ration between 0-100% and a frequency up to a few kilohertz. In one embodiment, the pulse width modulation signal can be generated by a microcontroller (not shown) or a pulse generator. Accordingly, this signal enables and disables the converter modulating the LED current.

In an alternative embodiment, the dimming of the LED components 618 and 620 may be accomplished by applying a control voltage to the LD pin of the integrated circuit chip 610 which is known as linear dimming. In linear dimming a control voltage of approximately 0 to 250 mV is applied to the LD pin which overrides the internally set threshold of 250 mV of the CS pin. It is appreciated that dimming may be accomplished using either of the above described method singly or in combination.

In one embodiment of the present invention, the integrated circuit chip 610 is equipped with over-voltage protection circuitry. In order to protect the integrated circuit chip 610 as well as the plurality of LED components 618 and 620, the integrated circuit chip 610 may be disabled by pulling the pulse width modulation pin to ground when the over-voltage condition is detected.

It is appreciated that the LED components discussed herein may be clear LED components. It is further appreciated that the LED components may be colored in some embodiments. For example, it is appreciated that the LED components may be colored red, yellow, blue, orange, green and white.

Referring now to FIG. 6B, an exemplary generic light engine driver circuit 600B having a DC input voltage in accordance with one embodiment of the present invention is shown. In this embodiment, the input voltage is DC. Accordingly, in this embodiment a converter for converting an AC input voltage to DC is not required. In this exemplary embodiment, the input voltage may vary substantially between 8 and 450 volt DC. The exemplary light engine 600B is operable with multiple input voltages while it is capable of providing over-voltage protection and dimming functionality. Moreover, the exemplary light engine 600B is capable of dissipating and transferring heat away from the light engine. These functionalities are described above.

Referring now to FIG. 6C, an exemplary light engine driver circuit 600C having a low DC input voltage for driving a single LED component in accordance with one embodiment of the present invention is shown. In this embodiment, a buck power conversion circuit 632 is coupled to the integrated circuit chip 610. The buck power conversion circuit 632 may be used to lower the input supply voltage. The buck power circuit 632 is operable within 8-30 volts. The buck circuit 632 provides a low DC voltage (e.g., 3.2 volts) to the integrated circuit chip 610. The light engine driver circuit 600C according to one embodiment is operable with one LED component 618 operating at 900 mA at 4.5 volts DC. The exemplary light engine 600C is operable with multiple input voltages while it is capable of providing over-voltage protection and dimming functionality. Moreover, the exemplary light engine 600C is capable of dissipating and transferring heat away from the light engine. These functionalities are described above.

Referring now to FIG. 6D, an exemplary light engine driver circuit 600D having a low DC input voltage for driving a plurality of LED components in accordance with one embodiment of the present invention is shown. In this embodiment, a buck-boost circuit 634 may be used to step-up the input voltage to a desired level. The light engine driver circuit 600D according to one embodiment is operable with a plurality of LED components (e.g., between three to eight LED components) 618 and 620 operating at 350 mA at 3.2 volts DC. Buck-boost converter 634 may require an output filter capacitor 616 to deliver power to the plurality of LED components 618 and 620 when a MOSFET transistor 626 is on such that flyback inductor 624 current is diverted from the output of the converter. The exemplary light engine 600D is operable with multiple input voltages while it is capable of providing over-voltage protection and dimming functionality. Moreover, the exemplary light engine 600D is capable of dissipating and transferring heat away from the light engine. These functionalities are described above.

A PCB board with at least one LED component along with other electronic components with various functionalities has been described above. There is a need to assemble the light engine into a structure (e.g., a cartridge) such that the assembled structure can be easily used in light fixtures. Assembling the light engine as described above into a structure usable in a fixture is described below.

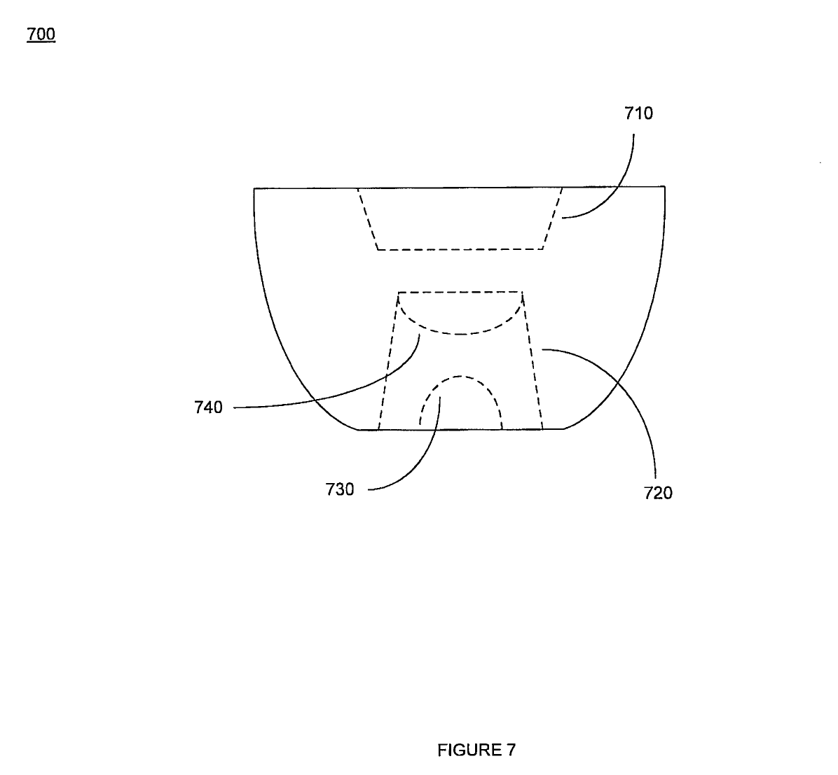

Referring now to FIG. 7, an optic for a one LED light engine in accordance with one embodiment of the present invention is shown. In one embodiment, the optical lens 700 is a clear glass or plastic and functions as a protective structure for the LED. In other embodiments, the optical lens magnifies and focuses the light emanating from the LED. The optical lens may be designed to diffuse the light arrays emanating from the LED at different angles. For example, the light arrays may be designed to diffuse at 10°, 20°, 35° 60° and 100°. However, it is appreciated that the diffusion of light arrays described above are exemplary and should not be construed to limit the scope of the present invention.

The single optical lens 700 has a top lens portion 710 which may focus and magnify light emanating from the LED. The thickness and the radius of the top lens portion 710 determines the magnification and the diffusion angle. It is appreciated that the top lens portion 710 may be semicircular or it may have other shapes. It is appreciated that in one embodiment of the present invention the surface of the top lens portion 710 may be a honeycomb surface.

In this embodiment, the single optical lens 700 comprises a hollow portion 730 for housing the LED inside it. Moreover, in this embodiment the single optical lens 700 further comprises a bottom lens portions 720 and 740, which are used to diffuse and magnify the light emanating from the LED further. The radius of the bottom lens portions 720 and 740 may be designed such that they alone or in combination with the top portion 710 achieve the desired magnification and the desired diffusion.

It is appreciated that even though the bottom lens portions 720 and 740 are shown separate from the top portion 710, they may nevertheless be combined to form a single piece lens portion. It is additionally appreciated that the embodiment of the present invention may be exercised with the top portion 710, the bottom portions 720 and 740 or any combination thereof. It is also appreciated that other embodiments of the present invention may comprise additional lens portions for diffusion and magnification of the light. It is further appreciated that in one embodiment of the present invention, the surfaces are polished to SPI A-1 lens grade diamond. It is also appreciated that the optical lens used may be a clear coated optical lens or colored. For example, a green, a yellow, a blue, a red and a warm white optical lens may be used.

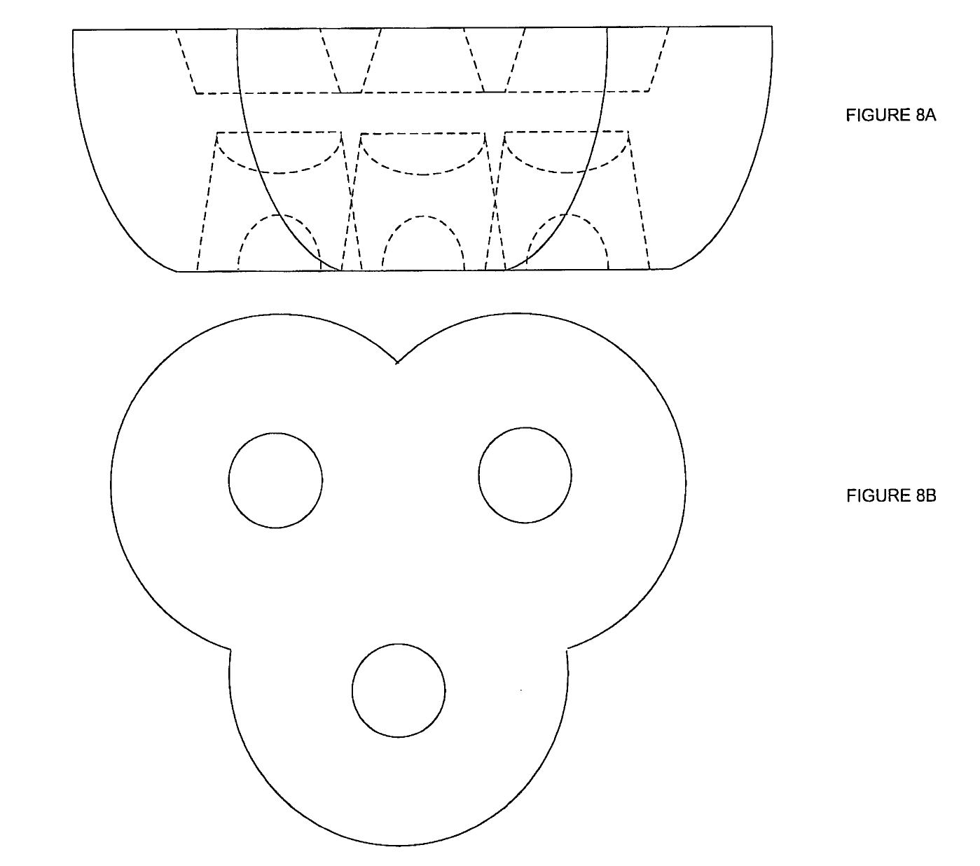

Referring now to FIGS. 8A and 8B, a side and a top view of optics for a three LED light engine in accordance with one embodiment of the present invention is shown. It is appreciated that the three LED optical lens may be designed such that the light emanating from each corresponding optical lens is combined with the light emanating from other optical lenses to form a single uniform light array at a certain diffusion rate. In one embodiment, the three optical lenses may be spaced such that three distinguished light is emanated. It is appreciated that the optical lens used may be a single piece optical lens comprising three single optical lenses as described in FIG. 7. Alternatively, it is appreciated that in one embodiment three piece optical lenses comprising three single optical lenses as described in FIG. 7 may be used. It is also appreciated that one embodiment may comprise a single piece optical lens for a plurality of LED components. It is further appreciated that the optical lenses may be clear or they may be colored. For example, the optical lenses may be green, yellow, blue, red and white.

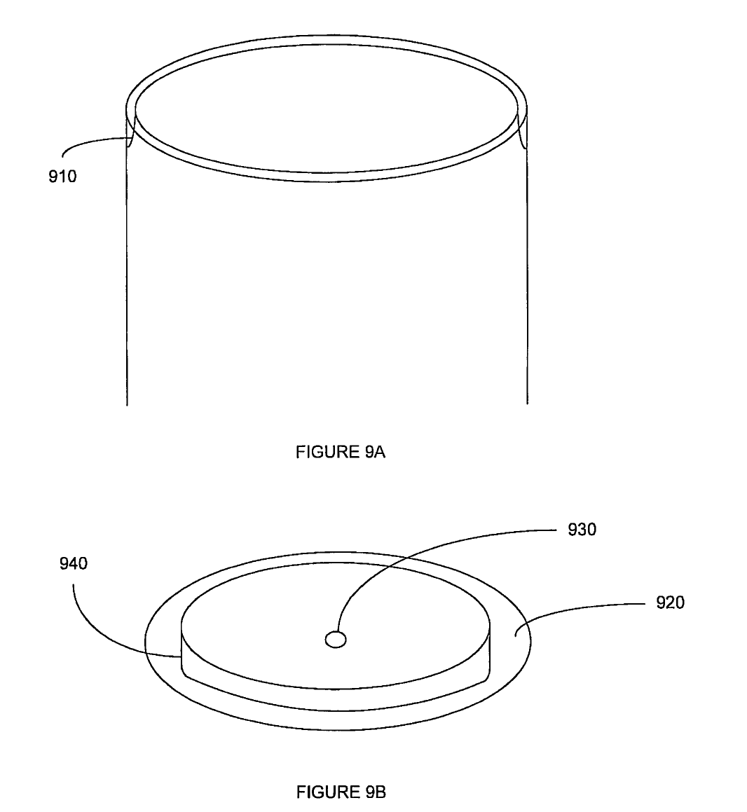

Referring now to FIGS. 9A and 9B, a top and a bottom portion of a cartridge for housing a single piece LED light engine in accordance with one embodiment of the present invention is shown. The cartridge housing may be an insulating housing that holds the light engine and the optical lens as described above. In this embodiment, the cartridge comprises two pieces. The top portion is shown in FIG. 9A and the bottom portion is shown in FIG. 9B.

The top portion comprises a holding mechanism 910 such that the optical lens mounted on the light engine is held in place and cannot slide out of the top portion of the cartridge. It is appreciated that the holding mechanism may be a hook, a flange, a rib, a shoulder or a lip. It is further appreciated that the holding mechanism may be partial or alternatively it may surround the inside of the cylindrical cartridge.

The bottom portion comprises a base 920 for the light engine as described above. Additionally the bottom portion may comprise an opening 930 (e.g., a hole) for allowing wires to extend through the cartridge such that the light engine can be connected to a power supply (e.g., a line voltage or DC supply). Moreover, the bottom portion may have a cylindrical portion 940 (e.g., a male portion) such that the cylindrical portion 940 can slide and lock into the top portion (e.g., a female portion). Accordingly, the top and the bottom portion are press-fit to form a single cartridge holding the light engine and its optical lens.

It is appreciated that the cartridge may be extended to hold a light engine comprising a plurality of drivers, a plurality of LED components and a plurality of optical lenses. It is also appreciated that in other embodiments, other methods for holding the top portion of the cartridge and the bottom portion of the cartridge may be used. For example, in one embodiment the top and the bottom portion may comprise a plurality of threads such that the top and the bottom portion of the cartridge can be secured in place by screwing them together. It is further appreciated that in one embodiment the top and the bottom portion may be held in place by using screws or similar components.

It is appreciated that the cylindrical cartridge shown is exemplary and is not intended to limit the scope of the invention. For example, the cartridge may be rectangular, spherical, or it may be a pyramid. It is further appreciated that the cartridge may act as an insulator or alternatively it may be metallic. It is also appreciated that the cartridge may be a single piece cartridge or it may comprise more than two pieces (not shown).

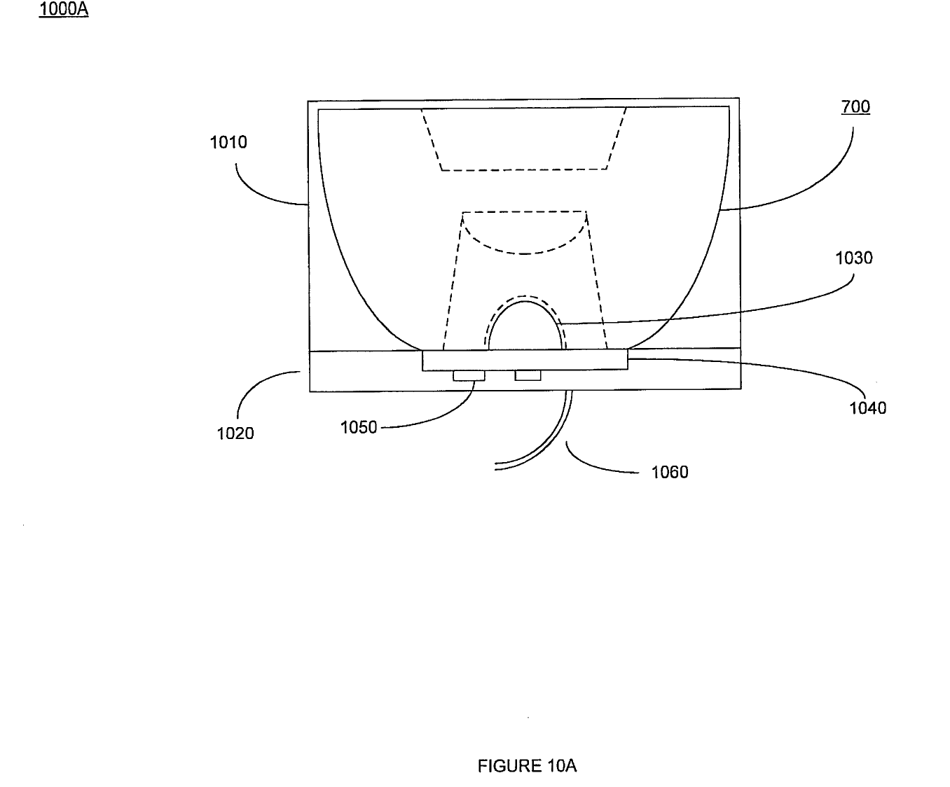

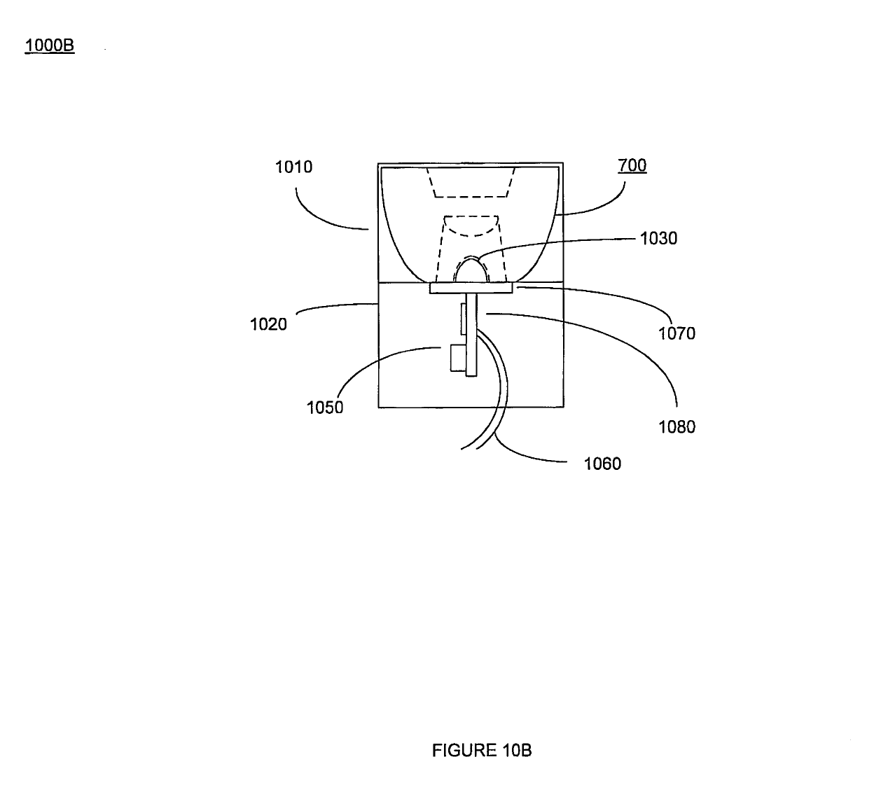

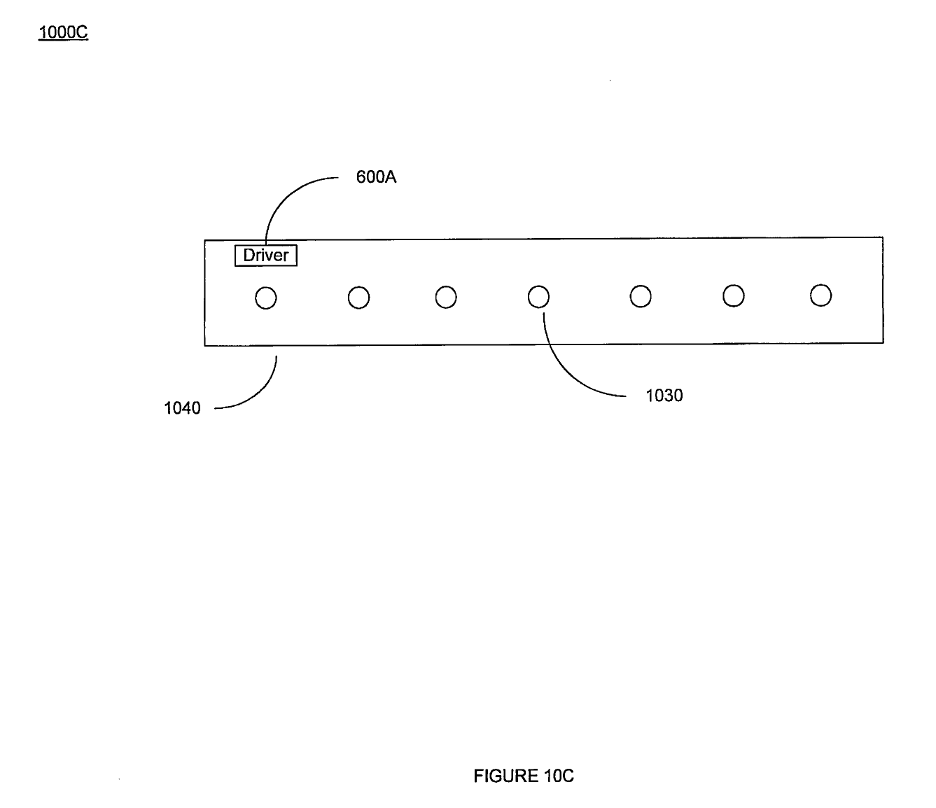

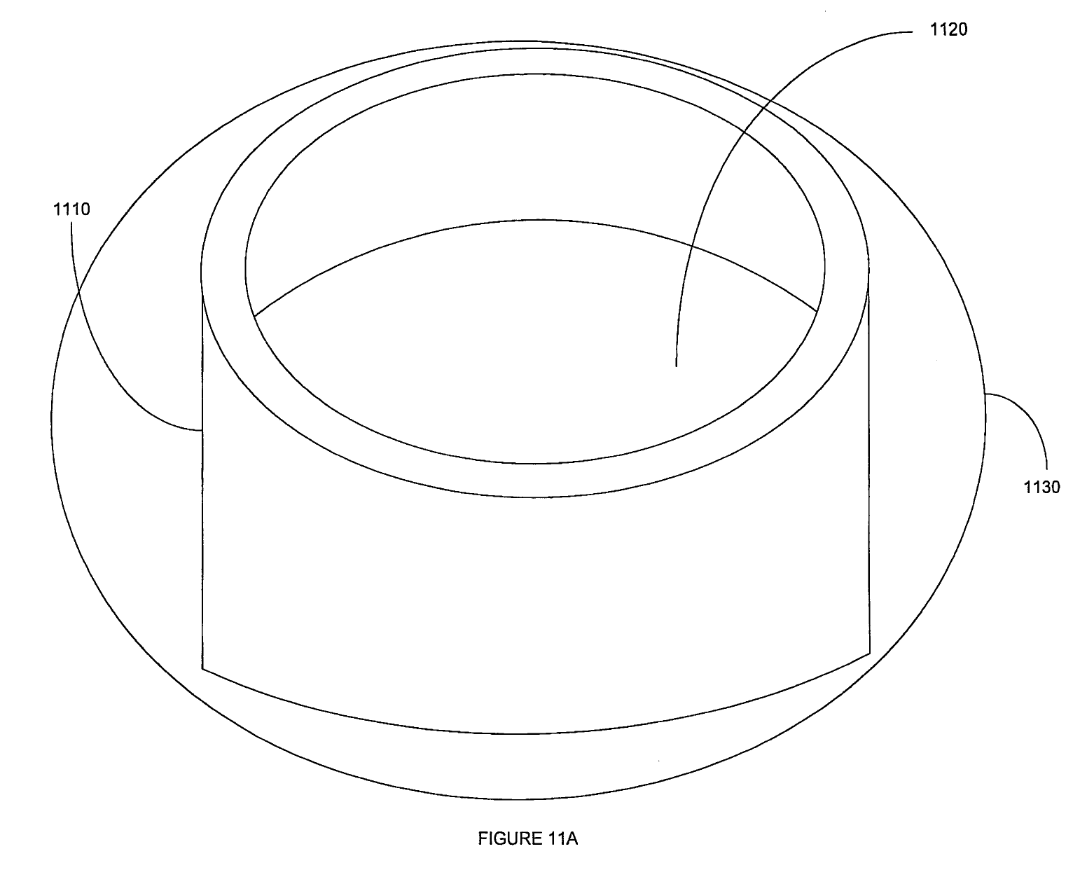

Referring now to FIG. 10A, the cartridge 1000A in accordance with FIGS. 9A and 9B housing a single piece LED light engine and an optic in accordance with one embodiment of the present invention is shown. The assembled cartridge 1000A comprises a top portion 1010 as described in FIG. 9A and a bottom portion 1020 as described in FIG. 9B. The bottom portion 1020 houses the PCB board 1040 that houses the LED 1030 and other electronic components 1050 (e.g., the light engine described above). Additionally, the bottom portion 1020 comprises an opening for allowing the wire 1060 to couple the plug or a power supply to the PCB board 1040. The top portion 1010 holds the optical lens 700 such that the optical lens is secured and does not slide out of the top portion of the cartridge (e.g., by using a hinge, a lip, a rib, a shoulder, or a flange).

Referring now to FIG. 10B, the cartridge in accordance with FIG. 9A and 9B housing a single piece LED light engine and an optic for narrow lighting fixture application in accordance with one embodiment of the present invention is shown. In this embodiment, the present invention is adapted such that the light engine can be used in narrow lighting fixture applications. Accordingly, the PCB board 1080 housing the electronic components (e.g., the driver circuitry) is substantially perpendicular to the heat sink 1070 which houses the LED component 1030. Therefore, designing the PCB board 1080 perpendicular to the heat sink 1070 reduces the circumference of the cartridge allowing it to be used in narrow light fixture applications.

It is appreciated that the cartridges described in FIGS. 9A, 9B, 10A and 10B can be used as a replaceable can for holding the light engine forming a light source. Accordingly, the cartridge housing forming a can allows the light source to be secured in a light fixture easily. As such, having a plurality of threads on the side of the can light source makes the replacement of the can light source inside a light fixture easier.

Referring now to FIG. 10C, a light engine strip 1000C in accordance with one embodiment of the present invention is shown. In one embodiment, a driver circuit 600B as described above is housed on a PCB board strip 1040. A plurality of LED components 1030 are coupled to the drive circuit 600B. It is appreciated any of the driver circuitries described above may be used (e.g., 600A, 600C, 600D). The light engine 1000C has over-voltage protection, dimming functionality, capable of accepting multiple input voltages and contains a heat sink as described above to dissipate and transfer generated heat away from the light engine. The strip light engine 1000C may be used in a tube for decorative purposes or it may be used for night lighting in the kitchen.

It is appreciated that any combination of the driver circuitries may be used and the embodiment shown should not be construed as limiting the scope of the present invention. In this embodiment, each LED component is controlled by one drive circuit. However, it is appreciated that more than one drive circuit may be used. Moreover, it is appreciated that the LED components used in this embodiment may be any color (e.g., red, green or blue).

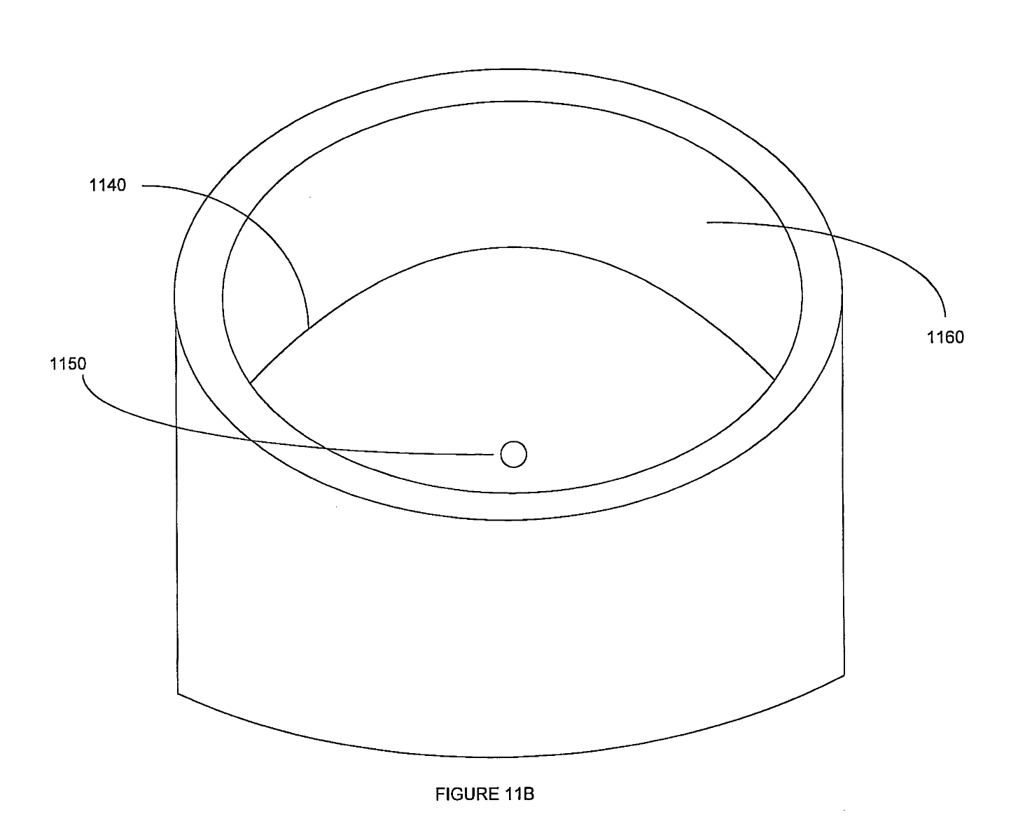

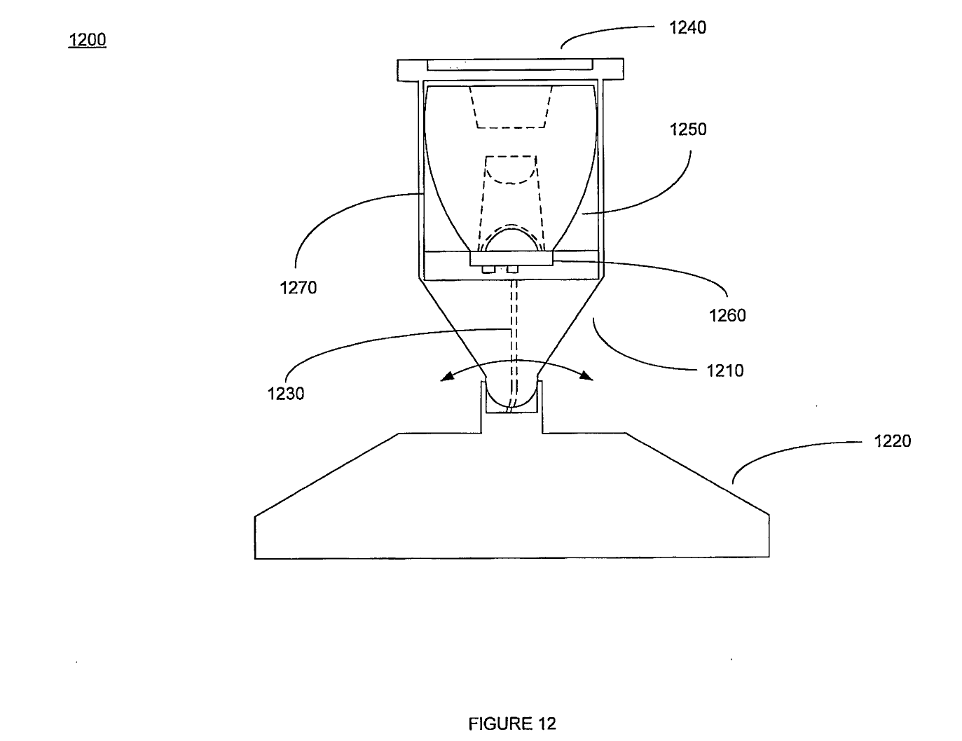

Referring now to FIG. 11A, a top portion of a fixture housing the encapsulated LED circuit board of FIGS. 10A and 10B forming a replaceable can in accordance with one embodiment of the present invention is shown. The top portion comprises a base 1130 which may be metallic. The top portion further comprises a glass piece or an optical piece portion 1120 which allows the light to be emanated from the LED to the surrounding environment. Moreover, the top portion comprises a wall 1110 that houses the optical lens and the light engine. It is appreciated that the top portion may house a plurality of optical lenses. It is also appreciated that top portion may house a trifocal optics. The top portion may hold the cartridge described in FIGS. 9A, 9B, 10A and 10B. It is further appreciated that the replaceable can as described herein holds a light engine that may comprise three, nine, twelve or thirty six LED components.

Referring now to FIG. 11B, a bottom portion of a fixture housing the encapsulated LED circuit board of FIGS. 10A and 10B forming a replaceable can in accordance with one embodiment of the present invention is shown. In this embodiment, the bottom portion comprises a base 1140 for holding the light engine having the optical lens mounted on it. It is appreciated that the light engine may comprise three, nine, twelve or thirty six LEDs or more as described above. The bottom portion further comprises a metallic wall 1160 (e.g., a male portion) that is press-fit to couple the bottom portion to the top portion (e.g., female portion) as described in FIG. 11A. Additionally, the bottom portion of the fixture may comprise an opening 1150 (e.g., a hole) for allowing a wire to extend through and couple the light engine to a line voltage or to a power supply residing outside of the fixture. The bottom portion of the fixture may hold the cartridge as described in FIGS. 9A, 9B, 10A and 10B. In one embodiment, the bottom portion may hold the can light source as described above.

Referring now to FIG. 1200, a directional flood, e.g., landscape, light fixture 1200 for housing a cartridge that houses the LED light engine of FIGS. 10A and 10B in accordance with one embodiment of the present invention is shown. The light fixture 1200 comprises a base portion 1220 which may be metallic. The base portion 1220 is coupled to the top portion 1210. It is appreciated that even though the top portion 1210 may be movable. For example, the top portion 1210 may have a linear motion mechanism (e.g., a sliding mechanism). Alternatively, the top portion 1210 may have a rotational mechanism (e.g., a hinge mechanism). Additionally, the top portion 1210 may have a combination of linear and rotational motion (e.g., cammed motion). It is appreciated that the invention may be practiced with non-movable portion. It is further appreciated that in other embodiments the bottom portion may be movable similar to the top portion.

The top portion 1210 further comprises a glass 1240 or similar structures for allowing the light to extend through the structure and to the surrounding. The glass 1240 may be made of glass or other materials such as a plexiglas. The top portion 1210 is operable to hold the cartridge 1270 described in FIGS. 9A, 9B, 10A and 10B. The cartridge 1270 is operable to hold the optical lens 1250 and the PCB board 1260 having electronic components and the LED mounted on it (e.g., the light engine). Additionally, the top portion 1210 may further comprise an opening such that a wire 1230 can pass through to supply power to the light engine. Additionally, the base portion 1220 may further comprise an opening (e.g., a hole) such that the wire 1230 can pass through and connect the light engine to a power supply or to a line voltage.

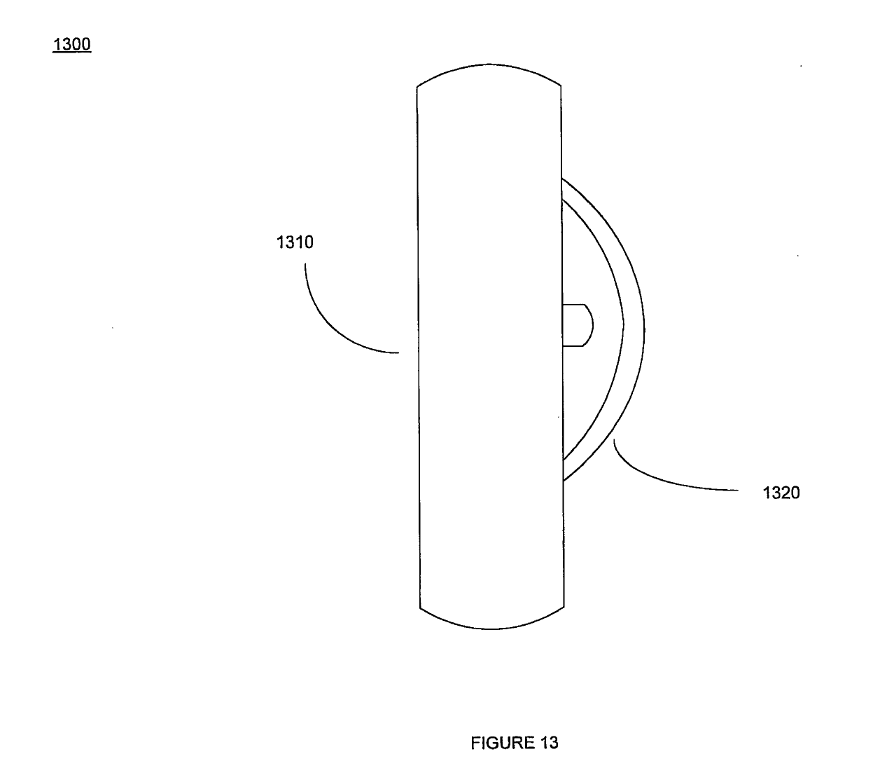

Referring now to FIG. 13, a two sided light fixture 1300 for housing a cartridge that houses the LED engine in accordance with one embodiment of the present invention is shown. The two sided fixture 1300 comprises a cylindrical portion 1310 and a base portion 1320. The cylindrical portion 1310 and the base portion 1320 may be made from metal alloys. The cylindrical portion 1310 is operable to house multiple cartridges. In this embodiment, two cartridges are used. Each cartridge as described above comprises a top portion and a bottom portion which houses the light engine comprising the PCB board, LED component and its related electronic components (e.g., a driver circuitry). In one embodiment, the two cartridges housed in the cylindrical portion 1310 face away from one another such that light emanates from both end (e.g., the top and the bottom) of the cylindrical portion 1310. The base 1320 of the fixture is to mount the fixture on a wall, a column or other structures.

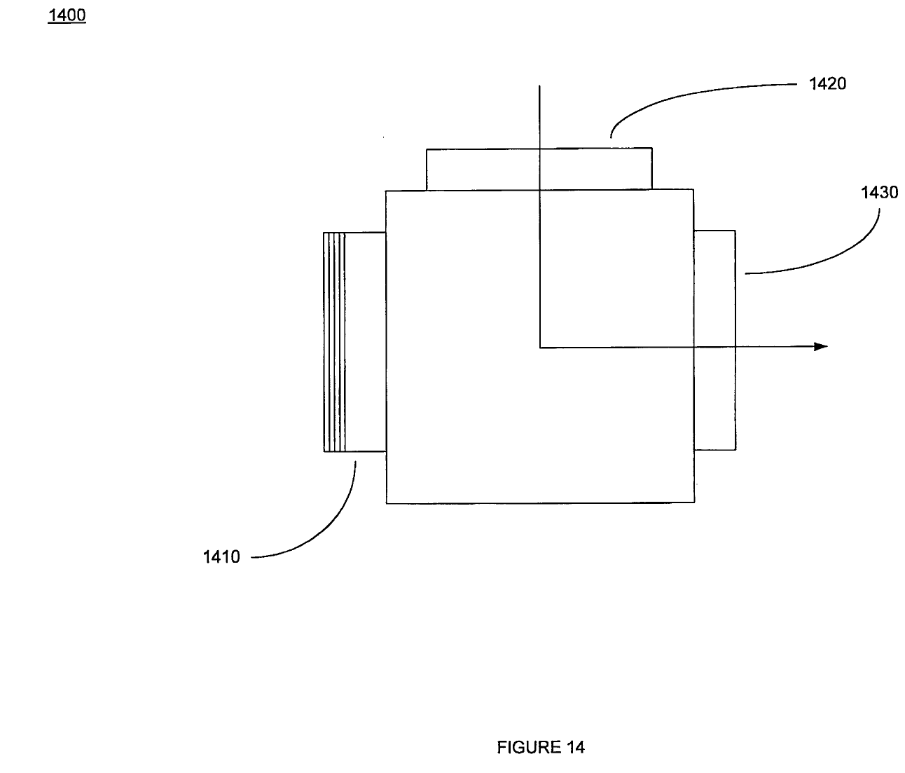

Referring now to FIG. 14, a light fixture 1400 for housing the LED engine for lighting the water flowing from one side of the fixture in accordance with an embodiment of the present invention is shown. In this embodiment, the cartridge is held in place in 1410 opening such that light emanates from the light engine to the right. It is appreciated that the cartridge may be insulated from other portions of the fixture 1400 such that it creates a seal. In one embodiment the seal is waterproof. In one embodiment, the water may flow through a hose coupled to the nozzle 1420. The water may flow from the top and is pushed out of the fixture 1400 through nozzle 1430. Accordingly, the light emanating from the light engine, lights the water flowing out of the nozzle 1430. As such, the fixture 1400 may be used in a water fountain, or it can be used in other water fixture structures and for other decorative purposes.

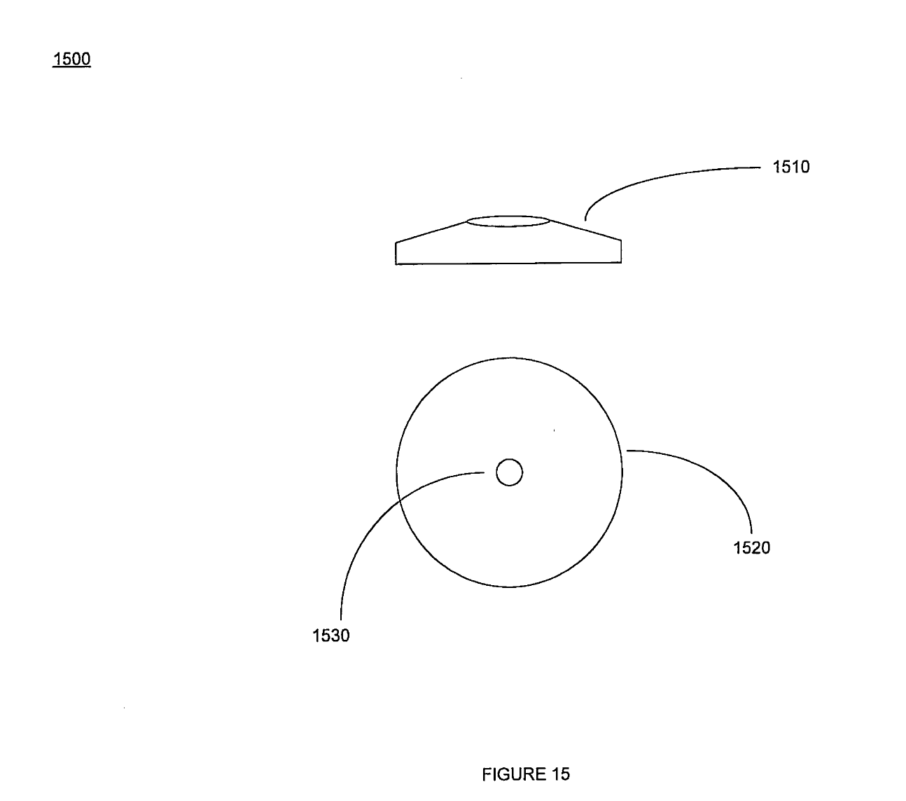

Referring now to FIG. 15, a puck light fixture 1500 for housing the LED engine for lighting underneath cabinets in accordance with an embodiment of the present invention is shown. In this embodiment, the puck light fixture 1500 houses the light engine described above. The light engine housed inside the puck light fixture 1500 emanates light from the top portion 1510. The bottom portion of the puck light fixture 1520 secures the base of the light engine. The bottom portion of the puck light fixture may have a hole 1530 such that a wire can be passed through it to supply power to the light engine secured inside the puck light fixture. Accordingly, the puck light fixture may be used as a light source for underneath a cabinet.

In the foregoing specification, embodiments of the invention have been described with reference to numerous specific details that may vary from implementation to implementation. Thus, the sole and exclusive indicator of what is, and is intended by the applicants to be, the invention is the set of claims that issue from this application, in the specific form in which such claims issue, including any subsequent correction. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A lighting device comprising:
a single printed circuit board comprising an integrated heat sink for dissipating heat;
a high efficiency light emitting diode (LED), coupled to said printed circuit board, operable to emit light; and
a driver circuitry, coupled to said printed circuit board and further coupled to drive said high efficiency LED, said drive circuitry capable of receiving multiple input voltages and supplying an appropriate power signal to drive said high efficiency LED.

2. The device as described in claim 1, wherein said drive circuitry further comprises:
over voltage protection circuitry for providing protection for said high efficiency LED due to inappropriate input voltages.

3. The device as described in claim 1 further comprising:
a transformer coupled to said printed circuit board operable to receive a line voltage input and supply a direct current (DC) voltage to said drive circuitry.

4. The device as described in claim 3, wherein said line voltage is substantially operable within the range of 90 to 260 alternating current (AC) volts.

5. The device as described in claim 1 further comprising a buck-boost circuit coupled to said printed circuit board and substantially operable within 8 to 30 volts direct current (DC) input voltage signal.

6. The device as described in claim 1, wherein said drive circuitry comprises:
internal dimming circuitry operable to control the brightness of said high efficiency LED and further operable to allow an external dimming device to control the dimming function of said internal dimming component.

7. The device as described in claim 1, wherein said heat sink comprises a plurality of vias within said printed circuit board for allowing air flow to dissipate heat generated from said high efficiency LED.

8. The device as described in claim 1, wherein said heat sink comprises a combination of nickel and silver plate layers to dissipate heat generated from said high efficiency LED.

9. The device as described in claim 1, wherein said high efficiency LED is operable substantially between 250 mA to 1 A at 3.2 volts and produces at least 55 lumens.

10. A lighting engine comprising:
a single printed circuit board comprising an integrated heat sink for dissipating heat;
a plurality of high efficiency light emitting diodes (LEDs), coupled to said printed circuit board, operable to emit light; and
a driver circuitry, coupled to said printed circuit board and further coupled to drive said plurality of high efficiency LEDs, said drive circuitry capable of receiving multiple input voltages and supplying an appropriate power signal to drive said plurality of high efficiency LEDs.

11. The lighting engine as described in claim 10, wherein said drive circuitry further comprises:
over voltage protection circuitry for providing protection for said plurality of high efficiency LEDs due to inappropriate input voltages.

12. The lighting engine as described in claim 10 further comprising:
a transformer coupled to said printed circuit board operable to receive a line voltage input and supply a direct current (DC) voltage to said drive circuitry.

13. The lighting engine as described in claim 12, wherein said line voltage is substantially operable within the range of 90 to 260 volts alternating current (AC).

14. The lighting engine as described in claim 10 further comprising a buck circuit coupled to said printed circuit board and substantially operable within 8 to 30 volts direct current (DC) input voltage signal.

15. The lighting engine as described in claim 10, wherein said drive circuitry comprises:
internal dimming circuitry operable to control the brightness of said plurality of high efficiency LEDs and further operable to allow an external dimming device to control the dimming function of said internal dimming component.

16. The lighting engine as described in claim 10, wherein said heat sink comprises a plurality of vias within said printed circuit board for allowing air flow to dissipate heat generated from said plurality of high efficiency LEDs.

17. The lighting engine as described in claim 10, wherein said heat sink comprises a combination of nickel and silver plate layers to dissipate heat generated from said plurality of high efficiency LEDs.

18. The lighting engine as described in claim 10, wherein said plurality of high efficiency LEDs is operable substantially between 250 mA to 1 A at 3.2 volts and produces at least 55 lumens.

19. A lighting source comprising:
a single printed circuit board comprising an integrated heat sink for dissipating heat;
a plurality of high efficiency light emitting diodes (LEDs), coupled to said printed circuit board, operable to emit light; and
a plurality of driver circuitries, coupled to said printed circuit board and further coupled to drive said plurality of high efficiency LEDs, said plurality of drive circuitries capable of receiving multiple input voltages and supplying an appropriate power signal to drive said plurality of high efficiency LEDs.

20. The lighting source as described in claim 19, wherein said plurality of drive circuitries further comprise:
over voltage protection circuitries for providing protection for said plurality of high efficiency LEDs due to inappropriate input voltages.

21. The lighting source as described in claim 19 further comprising:
a transformer coupled to said printed circuit board operable to receive a line voltage input and supply a direct current (DC) voltage to said plurality of drive circuitries.

22. The lighting source as described in claim 21, wherein said line voltage is substantially operable within the range of 90 to 260 volts alternating current (AC).

23. The lighting source as described in claim 19 further comprising a buck-boost circuit coupled to said printed circuit board and substantially operable within 8 to 30 volts direct current (DC) input voltage signal.

24. The lighting source as described in claim 19, wherein said plurality of drive circuitries comprises:
internal dimming circuitry operable to control the brightness of said plurality of high efficiency LEDs and further operable to allow an external dimming device to control the dimming function of said internal dimming component.

25. The lighting source as described in claim 19, wherein said heat sink comprises a plurality of vias within said printed circuit board for allowing air flow to dissipate heat generated from said plurality of high efficiency LEDs.

26. The lighting source as described in claim 19, wherein said heat sink comprises a combination of nickel and silver plate layers to dissipate heat generated from said plurality of high efficiency LEDs.

27. The lighting source as described in claim 19, wherein said plurality of high efficiency LEDs is operable substantially between 250 mA to 1 A at 3.2 volts and produces at least 55 lumens.

28. The lighting source as described in claim 19, wherein said plurality of driver circuitries independently control said plurality of high efficiency LEDs.
